(19) United States
(12) Patent Application Publication
(10) Pub. No.: US 2025/0116462 A1
(43) Pub. Date: Apr. 10, 2025

(54) Systems and Methods for Electrode Feeders and Electrode Seals

(71) Applicant: Veolia Nuclear Solutions, Inc., Lafayette, CO (US)

(72) Inventors: Brian Gaither, Pasco, WA (US); Brett E. Campbell, Richland, WA (US); Clay Nulle, Richland, WA (US); Ronald Mitchell, Richland, WA (US); Terrance Donovan Casey, Kennewick, WA (US)

(21) Appl. No.: 18/832,445

(22) PCT Filed: Jan. 19, 2023
(86) PCT No.: PCT/US2023/060935

§ 371 Date: Jul. 23, 2024

Related U.S. Application Data
(60) Provisional application No. 63/267,086, filed on Jan. 24, 2022.

(51) Int. Cl. F27D 11/10; H05B 7/103

(52) U.S. Cl. CPC F27D 11/10; H05B 7/103

(57) ABSTRACT

Systems and methods are provided for feeding an electrode into a container using an electrode feeder system. A fixed gripper is coupled to a support frame at or near a fixed base plate. A moveable gripper is positioned at or near a lower limit switch located at or near a base plate. The moveable gripper is coupled to one or more sliders that are coupled to the support frame. An electrode is positioned through the fixed gripper and the moveable gripper, and the fixed gripper is closed around the electrode. The moveable gripper is closed around the electrode and the fixed gripper is opened. The moveable gripper is lowered along a length of the electrode feeder system causing the electrode to be lowered into the container. The steps are repeated until a process occurring in the container is complete or the electrode is consumed.

### TECHNICAL FIELD

This disclosure relates generally to systems and methods for controlling feed rate of one or more electrodes in a vitrification system. More specifically, the disclosure relates to managing electrode consumption in a vitrification process.

### BACKGROUND

Vitrification systems and methods involve the vitrifying, or melting, of material(s) within vitrification chambers. In some vitrification systems and methods, two or more electrodes extend into the container where they make contact with the waste and/or a starter path which may include silica, glass frit, and other starter materials. Electrical current is applied to the electrodes which generates heat and the adjacent material(s) to be treated begin to melt. Application of electrical current to the electrodes may continue until the material contained in the vitrification chamber is completely melted. Electrodes are typically consumed in the vitrification process. Typically, electrodes are fed into the vitrification system by hand, which increases set up time and the possibility of electrode breakage. There is need for controlled electrode feeding systems and methods for manual or automated vitrification processes, particularly on an industrial process scale.

### GENERAL DESCRIPTION

An electrode feeder system is used to feed an electrode into a container where waste is vitrified. The electrode feeder system can include any suitable components and operate using any suitable methods.

In some embodiments, an electrode feeder system includes one or more of a base, a support frame coupled to the base, a fixed gripper coupled to at least one of the base or the support frame, and a movable gripper coupled to at least one of the base or the support frame and axially aligned with the fixed gripper along an axis. The movable gripper can be movable toward and away from the fixed gripper along the axis.

In some embodiments, a method for feeding an electrode into a container using an electrode feeder system includes the following. The electrode feeder system includes one or more of a fixed gripper and a movable gripper axially aligned with the fixed gripper. The method includes one or more of the following steps: (i) positioning the electrode through the fixed gripper and the movable gripper; (ii) gripping the electrode with the movable gripper; (iii) releasing the electrode from the fixed gripper; (iv) lowering the movable gripper while it is gripping the electrode; (v) gripping the electrode with the fixed gripper; (vi) releasing the electrode from the movable gripper; (vii) raising the movable gripper; and repeating steps (ii)-(vii).

An electrode is fed into a container using an electrode feeder system. In some embodiments, the system comprises one or more of the following components. For example, the system can include a fixed gripper that is coupled to a support frame at or near a fixed base plate. A movable gripper is positioned at or near a lower limit switch that is located at or near the base plate. The movable gripper is coupled to one or more sliders, and the one or more sliders are coupled to the support frame. An electrode is positioned through the fixed gripper and the movable gripper. The fixed gripper is closed around the electrode. The movable gripper is closed around the electrode, and the movable gripper is positioned at or near an upper limit switch wherein the upper limit switch is located at or near a top of the electrode feeder system. The fixed gripper is opened while the movable gripper is lowered along a length of the electrode feeder system causing the electrode to be lowered into the container. Lowering is stopped when the movable gripper comes into contact with the lower limit switch. The fixed gripper is then closed and the movable gripper is opened and raised to at or near the upper limit switch. The moveable gripper is then closed while the fixed gripper is opened, and the steps are repeated until the electrode installation process is complete. In an industrialized vitrification process, automated or manual electrode feeder apparatus enhance process speed and electrode material continuity and reduce the possibility of damage to electrodes during installation, as well as enhance worker safety due to the mechanical feeder process.

In some embodiments, a method for feeding an electrode into a container using an electrode feeder system, includes one or more of the following steps: (i) opening a fixed gripper, wherein the fixed gripper is coupled to a support frame at or near a fixed base plate; (ii) positioning a movable gripper at or near a lower limit switch wherein the lower limit switch is located at or near the fixed base plate, and wherein the movable gripper is coupled to one or more sliders, and the one or more sliders are coupled to the support frame; (iii) positioning the electrode through the fixed gripper and the movable gripper; (iv) closing the fixed gripper around the electrode; (v) positioning the movable gripper at or near an upper limit switch located at or near a top of the electrode feeder system; (vi) closing the movable gripper around the electrode; (vii) opening the fixed gripper; (viii) lowering the movable gripper along a length of the electrode feeder system causing the electrode to be lowered into the container; (ix) stopping lowering when the movable gripper comes into contact with the lower limit switch; (x) closing the fixed gripper; (xi) opening the movable gripper; (xii) raising the movable gripper to a position at or near the upper limit switch; (xiii) closing the movable gripper; (xiv) opening the fixed gripper; and (xv) repeating steps (viii)-(xiv) until at least one of a process occurring in the container is complete or the electrode is consumed.

In some embodiments, an electrode feeder system, includes one or more of the following components: a base plate and a support frame, wherein the support frame is coupled to the base plate; a fixed gripper, wherein the fixed gripper is coupled to the support frame at or near the base plate; one or more sliders; a movable contactor, wherein the movable contactor is slidably coupled to the one or more sliders, and wherein the movable contactor includes: a movable gripper, and a contactor, an upper limit switch, wherein the upper limit switch is coupled to at least one of the support frame or the one or more sliders; a lower limit switch, wherein the lower limit switch is coupled to at least one of the support frame, the base plate, or the one or more sliders; and a motor, wherein the motor is operable to cause the movable contactor to slide up or down along the one or more sliders.

The general description is provided to give a general introduction to the described subject matter as well as a synopsis of some of the technological improvements and/or advantages it provides. The general description and background are not intended to identify essential aspects of the described subject matter, nor should they be used to constrict or limit the scope of the claims. For example, the scope of the claims should not be limited based on whether the recited subject matter includes any or all aspects noted in the general description and/or addresses any of the issues noted in the background.

### DESCRIPTION OF DRAWINGS

The preferred and other embodiments are described in association with the accompanying drawings in which:

FIG. 1 depicts an exemplary electrode.

FIG. 2 depicts an embodiment of an electrode feeder configuration on the top of a vitrification container.

FIG. 3A depicts an isometric view of an embodiment of an electrode feeder assembly.

FIG. 3B depicts a side view of the embodiment of the electrode feeder assembly of FIG. 3A.

FIG. 3C depicts a top view of the embodiment of the electrode feeder assembly of FIG. 3A.

FIG. 3D depicts a front view of the embodiment of the electrode feeder assembly of FIG. 3A.

FIG. 3E depicts a cross-sectional side view of the embodiment of the electrode feeder assembly including an electrode and electrode seal assembly of FIG. 3A.

FIG. 4A depicts an isometric view of an embodiment of a fixed gripper assembly.

FIG. 4B depicts a top view of an embodiment of the fixed gripper assembly of FIG. 4A.

FIG. 4C depicts a front view of an embodiment of the fixed gripper assembly of FIG. 4A.

FIG. 4D depicts a side view of an embodiment of the fixed gripper assembly of FIG. 4A.

FIG. 4E depicts Section E-E of an embodiment of the fixed gripper assembly of FIG. 4A.

FIG. 5 depicts an embodiment of a feeder contactor assembly.

FIG. 6A depicts an isometric view of an embodiment of an electrode feeder assembly.

FIG. 6B depicts a side view of an embodiment of the electrode feeder assembly of FIG. 6A.

FIG. 6C depicts a top view of an embodiment of the electrode feeder assembly of FIG. 6A.

FIG. 6D depicts a front view of an embodiment of the electrode feeder assembly of FIG. 6A.

FIG. 7A depicts an isometric view of an embodiment of a fixed gripper assembly.

FIG. 7B depicts a top view of an embodiment of the fixed gripper assembly of FIG. 7A.

FIG. 7C depicts a front view of an embodiment of the fixed gripper assembly of FIG. 7A.

FIG. 7D depicts a side view of an embodiment of the fixed gripper assembly of FIG. 7A.

FIG. 7E depicts an exploded view of an embodiment of the fixed gripper assembly of FIG. 7A.

FIG. 8A depicts an isometric view of an embodiment of a movable contactor assembly.

FIG. 8B depicts an exploded view of an embodiment of the movable contactor assembly of FIG. 8A.

FIG. 9A depicts an isometric view of an electrode cap embodiment.

FIG. 9B depicts a top view of the electrode cap embodiment of FIG. 9A.

FIG. 9C depicts a front view of the electrode cap embodiment of FIG. 9A.

FIG. 9D depicts Section A-A of the electrode cap embodiment of FIG. 9A.

FIG. 10A depicts an isometric view of an electrode seal assembly embodiment.

FIG. 10B depicts a top view of the electrode seal assembly embodiment of FIG. 10A.

FIG. 10C depicts Section C-C of the electrode seal assembly embodiment of FIG. 10A.

FIG. 11A depicts an isometric view of an electrode seal base embodiment.

FIG. 11B depicts a top view of the electrode seal base embodiment of FIG. 11A.

FIG. 11C depicts a front view of the electrode seal base embodiment of FIG. 11A.

FIG. 11D depicts Section B-B of the electrode seal base embodiment of FIG. 11A.

FIG. 12A depicts an isometric view of an electrode seal cap embodiment.

FIG. 12B depicts a top view of the electrode seal cap embodiment of FIG. 12A.

FIG. 12C depicts a front view of the electrode seal cap embodiment of FIG. 12A.

FIG. 12D depicts Section A-A of the electrode seal cap embodiment of FIG. 12A.

FIG. 13A depicts an isometric view of an electrode seal embodiment.

FIG. 13B depicts a top view of the electrode seal embodiment of FIG. 13A.

FIG. 13C depicts Section D-D of the electrode seal embodiment of FIG. 13A.

FIG. 14 depicts possible electrode connections in a four-electrode embodiment.

FIG. 15 shows one embodiment of an electronic computing device that can be used to control operation of the electrode feeder.

FIG. 16 shows various embodiments of the devices that can be included as part of the electronic computing device 101 in FIG. 15.

### DETAILED DESCRIPTION OF EMBODIMENTS

Before any embodiments of the present disclosure are explained in detail, it is to be understood that the systems and methods disclosed herein are not limited in its application to the details of construction and the arrangement of components set forth in the following description or illustrated in the accompanying drawings. The systems and methods disclosed herein are capable of other embodiments and of being practiced or of being carried out in various ways. It should be noted that there are many different and alternative configurations, devices, and technologies to which the disclosed embodiments may be applied. The full scope of the embodiments is not limited to the examples that are described below.

In the following examples of the illustrated embodiments, references are made to the accompanying drawings which form a part hereof, and in which is shown by way of illustration various embodiments in which the systems, methods, processes, and/or apparatuses disclosed herein may be practiced. It is to be understood that other embodiments may be utilized, and that structural and functional changes may be made without departing from the scope of the present disclosure.

Vitrification is used to destroy or immobilize hazardous waste by exposure to high temperatures that results in the contaminants being eliminated or entrained within a glass matrix. The process reduces or eliminates pre-treatment requirements, increases waste load capacity, and reduces maintenance costs as compared to other hazardous waste processing and storage methods. Some hazardous waste processing and storage methods are only suitable for a single waste type or classification whereas vitrification can be applied to a wider range of hazardous materials. Vitrified glass has a high waste loading capacity and is considered stable. In an industrialized vitrification process, automated or manual electrode feeder apparatus enhance process speed and electrode material continuity and reduce the possibility of damage to electrodes during installation, as well as enhance worker safety due to the mechanical feeder process.

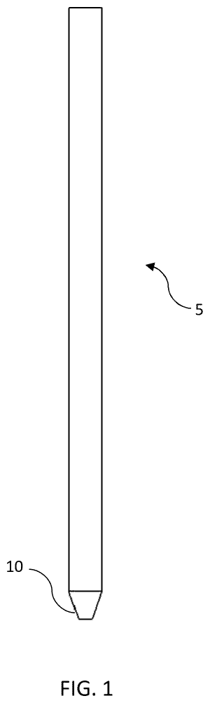

FIG. 1 depicts an exemplary electrode 5. An electrode 5 is an electrical conductor used to make contact with a nonmetallic part of a circuit. Two or more electrodes 5 may be used to conduct energy within a vitrification container to facilitate vitrification of the materials within. The length of an electrode 5 is generally greater than the diameter. In some embodiments, one end 10 of the electrode 5 is tapered. A tapered end 10 may facilitate alignment of the electrode 5 during insertion into a vitrification container. In some embodiments, two or more electrodes 5 may be fed into a vitrification container as the melt progresses, maintaining the end of the electrodes 5 at or near the bottom of the melt area. In some embodiments, a portion of each of the two or more electrodes 5 remains extended above the vitrification container during the melt process.

Long electrodes 5 are more likely to break than shorter ones due to increased moment arm; therefore, the two or more electrodes 5, in some embodiments, may be threaded to allow shorter sections to be added incrementally. Typically, smaller diameter electrodes 5 may be male/female and larger diameter electrodes 5 may be female/female and attached with a double threaded male nipple. In some embodiments, new electrode sections may be added automatically using a control system.

Electrodes 5 may be composed of graphite or other materials including both consumable and non-consumable electrode materials. Electrodes 5 may be at least one of conductive, heat resistant, and/or corrosion resistant. Graphite electrodes are commonly used in electric arc furnaces due to their excellent electrical and thermal conductivity, high temperature strength, and low thermal expansion. In some embodiments, consumable electrodes may be fed incrementally and/or at a regular rate throughout a vitrification process.

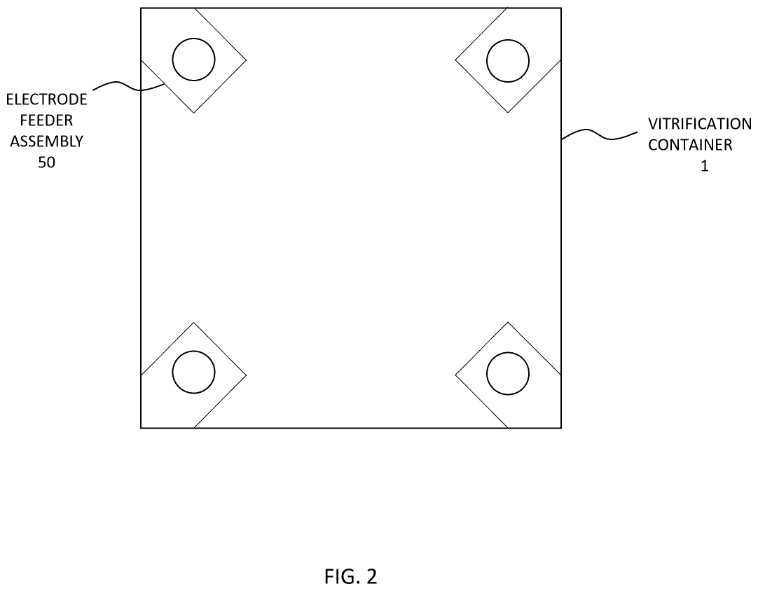

FIG. 2 depicts an embodiment of a generic electrode feeder 50 configuration on the top of a vitrification container 1. The vitrification container is a container in which the electrode(s) 5 (FIG. 1) are inserted and in which a vitrification takes place. In some embodiments, the vitrification container 1 may be composed of steel and/or one or more other non-combustible materials. In some embodiments, cast refractory materials may be added to one or more of the walls and the floor of the vitrification container 1. In some embodiments, one or more of the side walls may be removable.

In some embodiments, the two or more electrodes 5 (FIG. 1) may be fed into the vitrification container 1 using electrode feeder assemblies 50.

### Example A: Electrode Feeder Assembly Embodiment

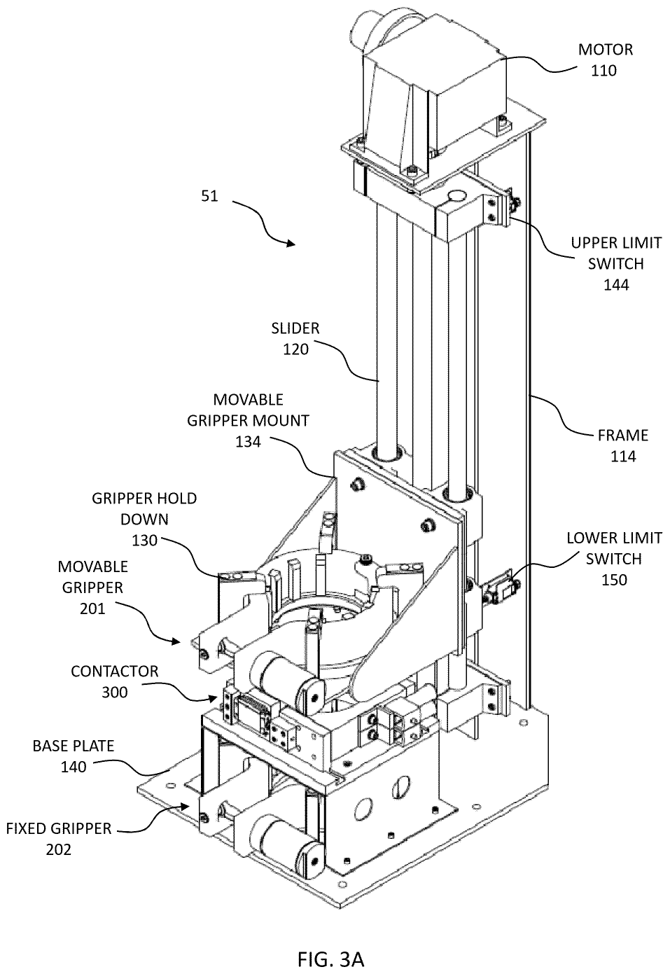

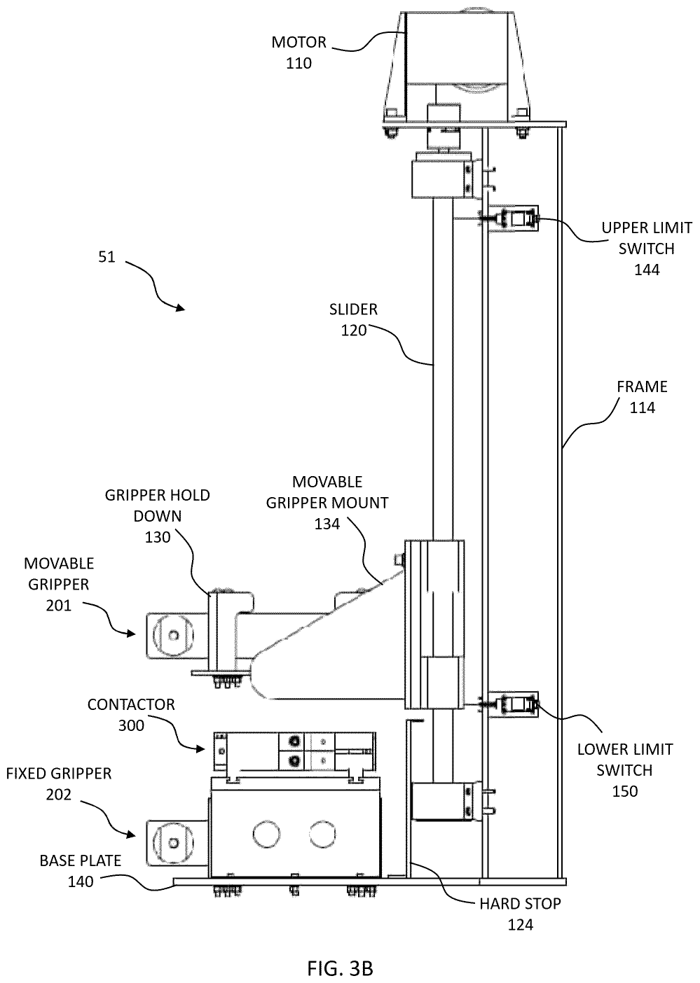

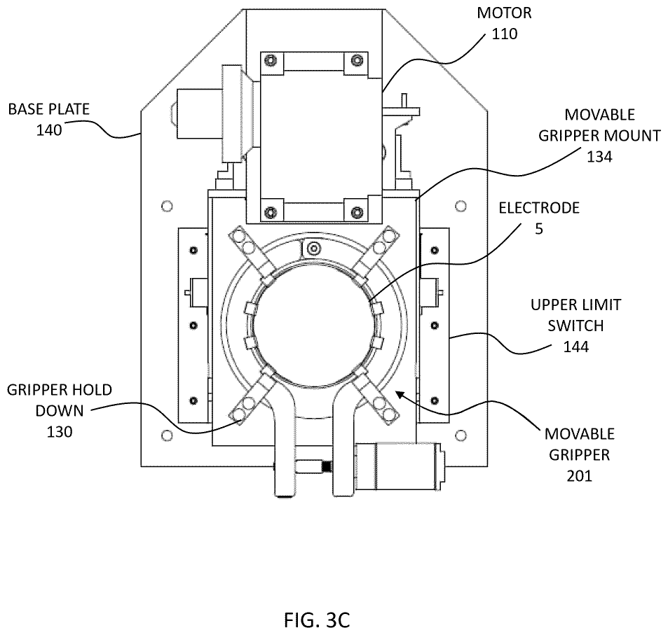

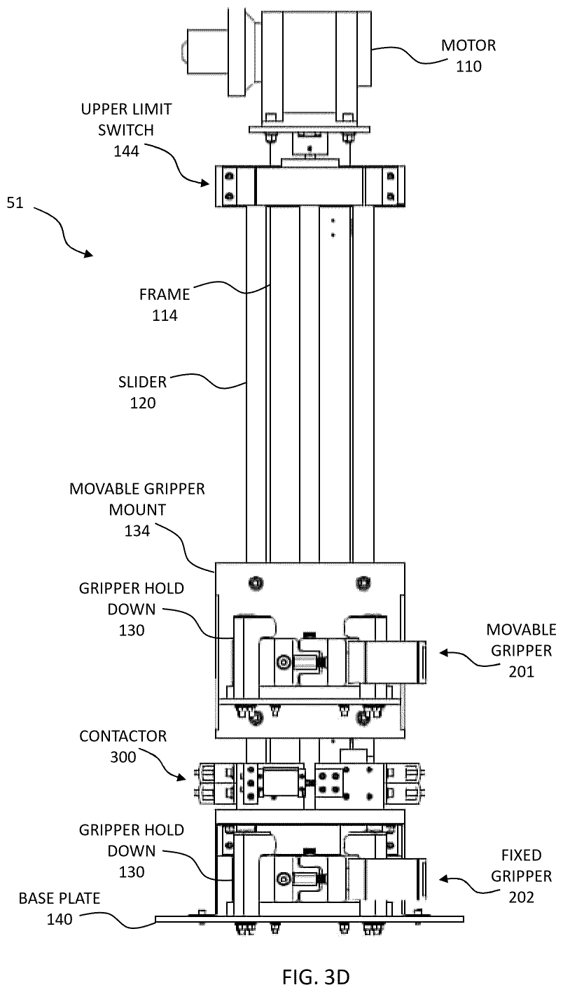

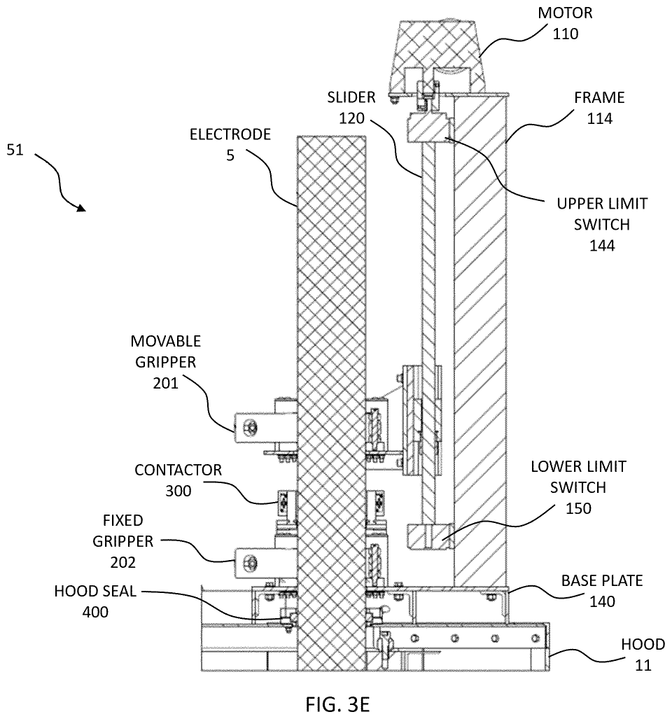

FIGS. 3A through 3D depict isometric, side, top, and front views, respectively, of an electrode feeder 51 embodiment. The depicted electrode feeder 51 comprises a motor 110, a frame 114, sliders 120, hard stop 124, gripper hold downs 130, movable gripper mount 134, base plate 140, upper limit switch 144, lower limit switch 150, movable gripper 201, fixed gripper 202, and contactor 300. The frame 114 and base plate 140 form the primary structure to which the other parts are coupled, in the depicted embodiment. In some embodiments, the structure is capable of supporting an electrode weight of more than 600 pounds and/or a diameter of 8 inches; however, other electrode sizes and weights are possible. For segmented electrodes, additional electrode segments may be added while an electrode 5 is installed in the electrode feeder assembly 51.

The motor 110, which may be an air motor, in some embodiments, may be used to operate the movable gripper 201. In the depicted embodiment, the movable gripper 201 is coupled to the movable gripper mount 134 which slides vertically along sliders 120. The movable gripper 201 is coupled to the movable gripper mount 134 via one or more (four in the depicted embodiment) gripper hold downs 130. A hard stop 124 prevents the movable gripper 201 and movable gripper mount 134 from coming into contact with the contactor 300 (depicted and disclosed in more detail in FIG. 5). The upper limit switch 144 and the lower limit switch 150 control the vertical range of motion of the movable gripper 201.

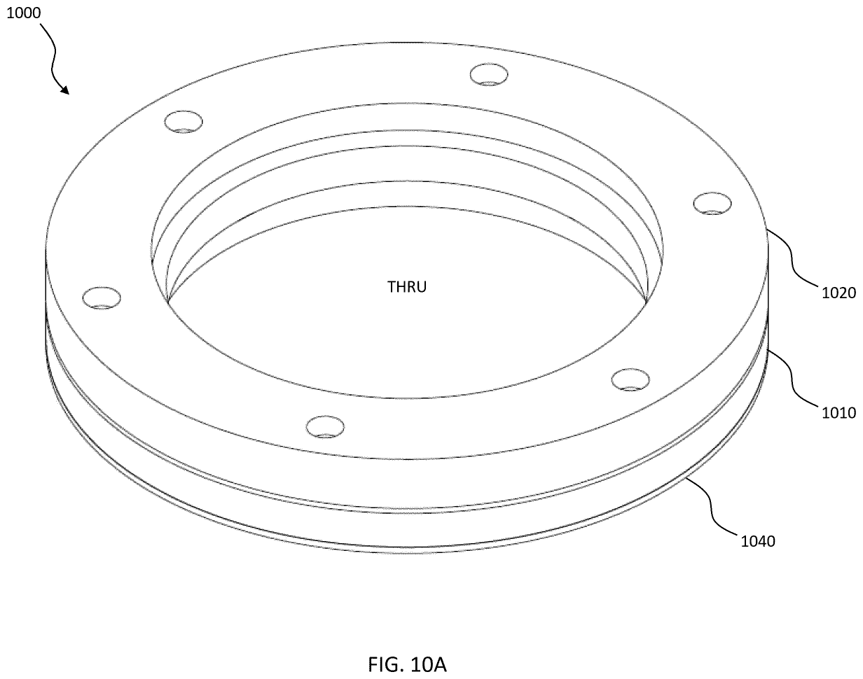

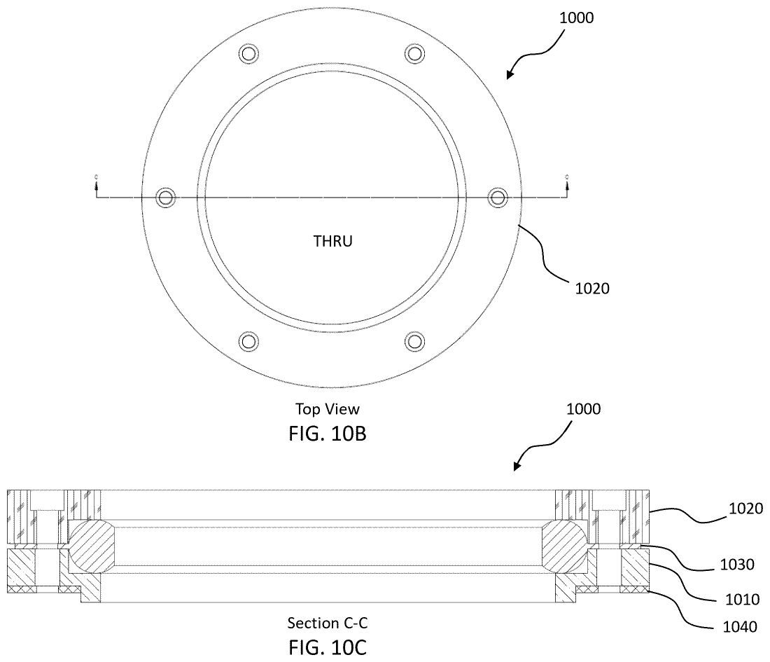

FIG. 3E depicts a cross-sectional view of the electrode feeder 51 embodiment of FIGS. 3A-3D. The depicted embodiment shows how an electrode 5 may be positioned in the system including a hood seal 400 (also referred to herein as an electrode seal assembly), for sealing between the electrode 5 and the hood 11 of the vitrification container 1 (FIG. 2). An embodiment of an electrode seal assembly is depicted and disclosed in FIGS. 10A-13C.

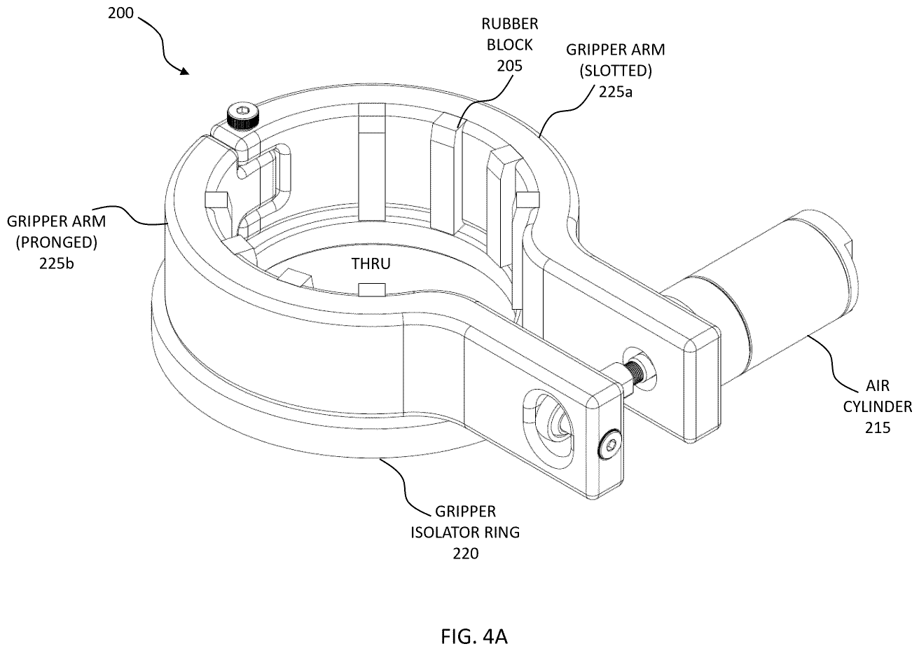

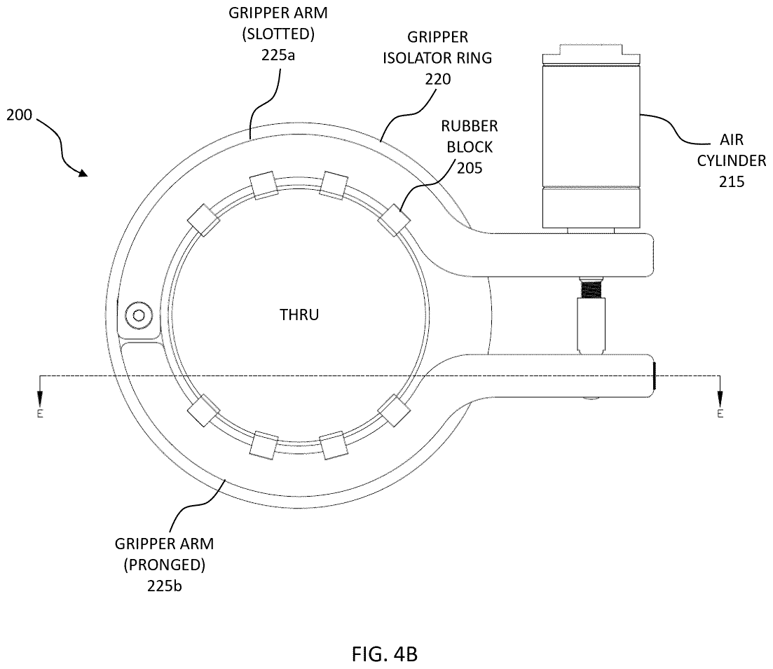

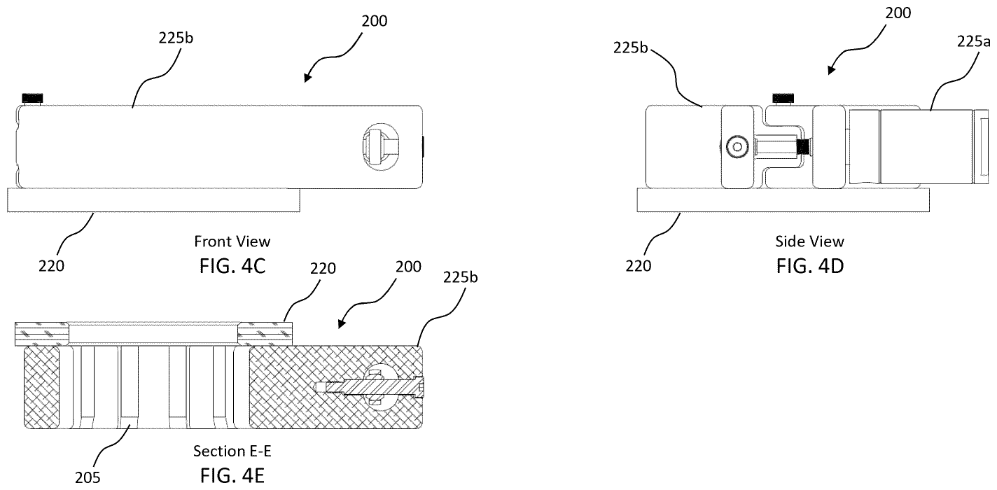

FIGS. 4A through 4E depict isometric, top, front, side, and section views, respectively, of a feeder gripper assembly 200 embodiment. In some embodiments, both the movable gripper 201 (FIGS. 3A-3E) and the fixed gripper 202 (FIGS. 3A-3E) may be essentially the same or similar in build and operation with the primary difference being that the fixed gripper 202 (FIGS. 3A-3E) remains fixed in position at all times and the movable gripper 201 (FIGS. 3A-3E) may move vertically up and down the feeder assembly 50, 51 (FIGS. 2-3E). The depicted gripper embodiment 200 comprises one or more blocks 205 (which may be composed of rubber or other insulating material, in some embodiments), an air cylinder 215, a gripper isolator ring 220, a slotted gripper arm 225a, and a pronged gripper arm 225b. The prong on the pronged gripper arm 225b fits into the slot on the slotted gripper arm 225a and the two arms are coupled together such that they may rotate about the coupling point. This movement allows for the strength of the grip to be tightened or loosened as needed. Grip force is controlled by the air cylinder 215. Gripper arms 225a and 225b control vertical motion of the electrode(s). The gripper isolator ring 220 and the one or more blocks 205 serve to insulate the componentry from the electrode(s) (FIGS. 1 and 3E). The gripper isolator ring 220 also aids in horizontal alignment of the electrode along its inner diameter. The one or more blocks 205 may be composed of rubber or other insulating material, in some embodiments. In the depicted embodiment, each gripper arm 225a,b comprises four blocks 205; however, the quantity and size of the blocks may vary between embodiments.

FIG. 5 depicts an embodiment of a feeder contactor 300. The contactor 300 serves to control the amount of force applied to the electrode(s) 5 (FIGS. 1 and 3E) to ensure good electrical contact between the brush 320 and the electrode(s) 5. The depicted contactor 300 comprises a mount block 305, base plate 310, terminal 315, brush 320, and an air ram 325. The mount block 305 couples the contactor 300 to the base 140 of the feeder assembly 50, 51 (FIGS. 2-3E). The base plate 310 is coupled to the mount block 305 and raises the contactor 300 above the fixed gripper 202 (FIGS. 3A-3E) such that the contactor is positioned between the fixed gripper 202 (FIGS. 3A-3E) and the movable gripper 201 (FIGS. 3A-3E). The position of the contactor 300 may vary between embodiments.

In some embodiments, the brush 320 material has good electrical properties to enable transmission of power from the terminal 315 to the electrode(s) 5. In some embodiments, the brush 320 material comprises a copper alloy.

In some embodiments, the contactor 300 design uses air pressure to maintain good electrical contact between the brush 320 and the electrode(s) 5. Adjusting air pressure allows for different electrical contact properties to be achieved. During operation, the electrode may slide through the brush 320 while the brush 320 maintains the proper amount of contact force with the electrode 5, even if the electrode 5 has imperfections (i.e., the diameter is slightly different, not circular, has pitting or other damage, etc.).

### Example B: Electrode Feeder Assembly Embodiment

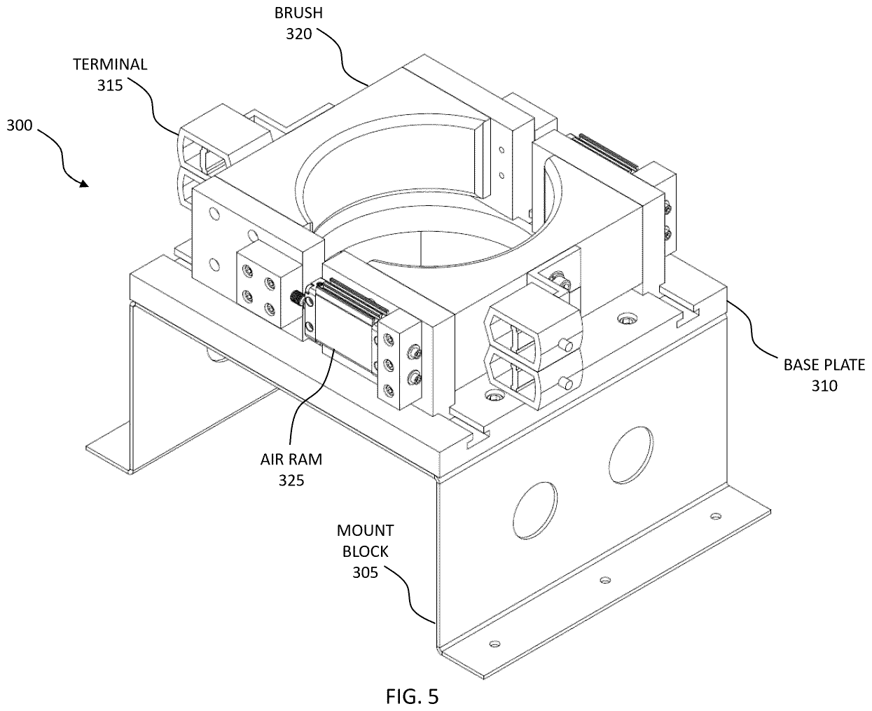

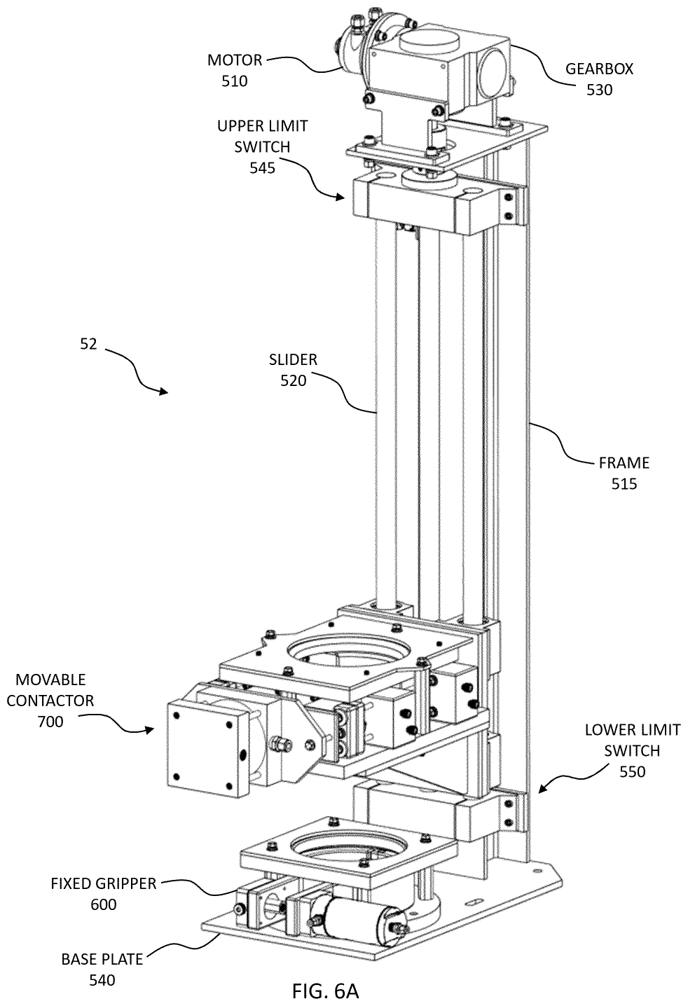

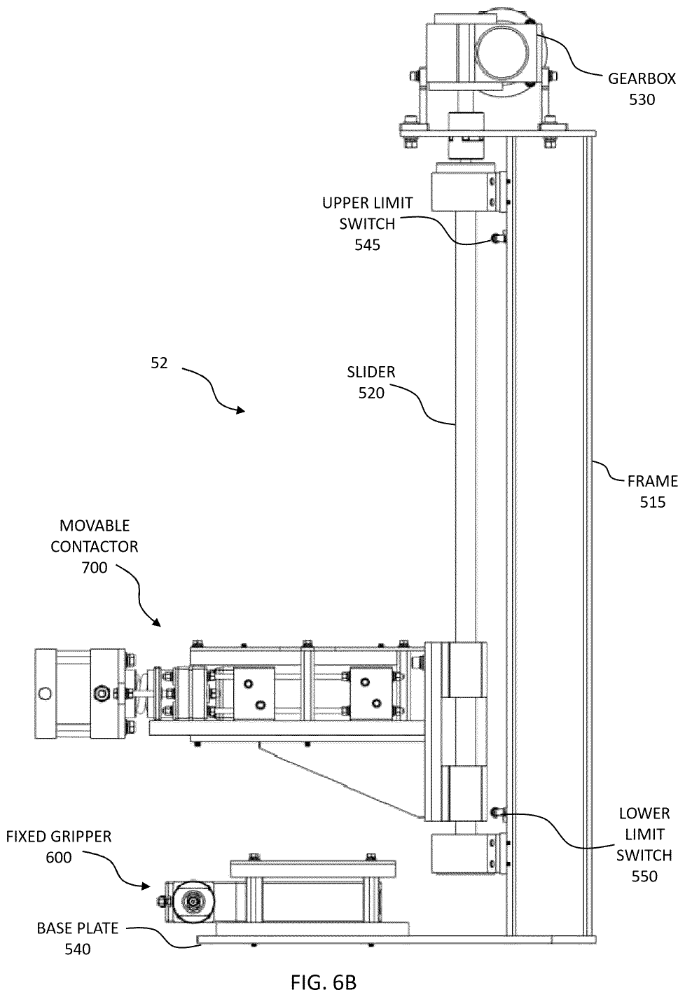

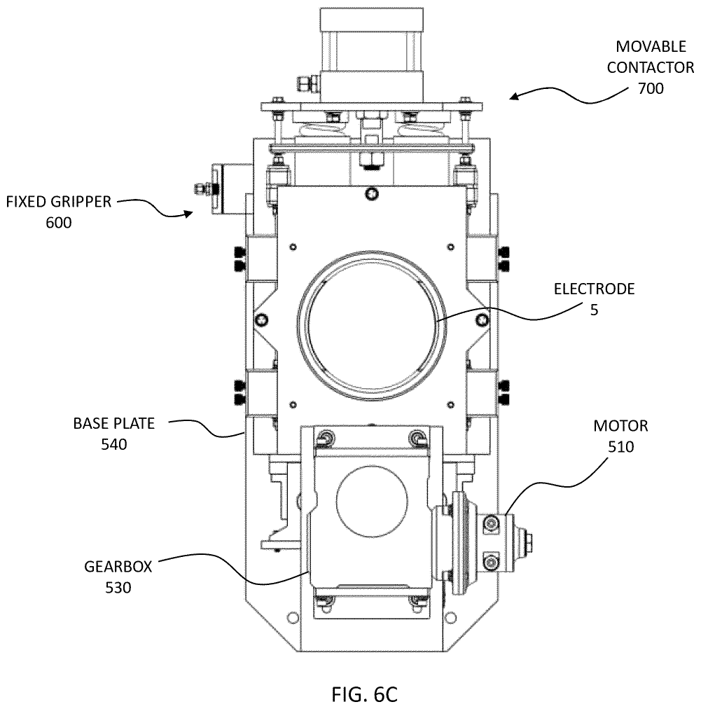

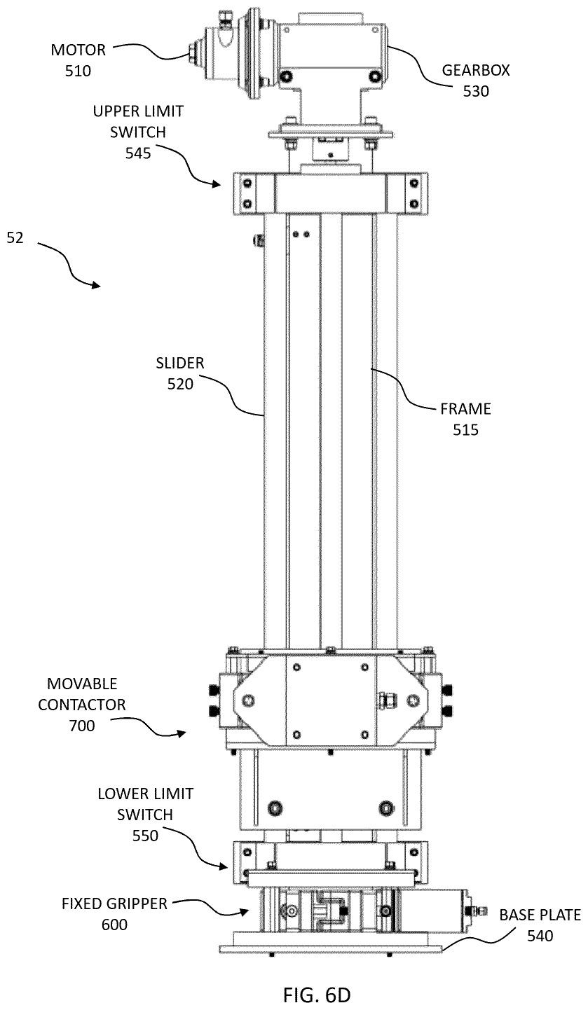

FIGS. 6A through 6D depict isometric, side, top, and front views, respectively, of an embodiment of an electrode feeder assembly 52. The depicted electrode feeder 52 comprises a motor 510, a frame 515, sliders 520, gearbox 530, base plate 540, upper limit switch 545, lower limit switch 550, movable contactor 700, and fixed gripper 600. The frame 515 and base plate 540 form the primary structure to which the other parts are coupled, in the depicted embodiment. In some embodiments, the structure is capable of supporting an electrode weight of more than 600 pounds and/or a diameter of 8 inches; however, other electrode sizes and weights are possible. For segmented electrodes, additional segments may be added while an electrode 5 is installed in the electrode feeder assembly 52.

In some embodiments, the motor 510, which may be an air motor or other motor type, may be used to operate the movable contactor 700. The movable contactor 700 slides vertically along sliders 520. The upper limit switch 545 and the lower limit switch 550 control the vertical range of motion of the movable contactor 700.

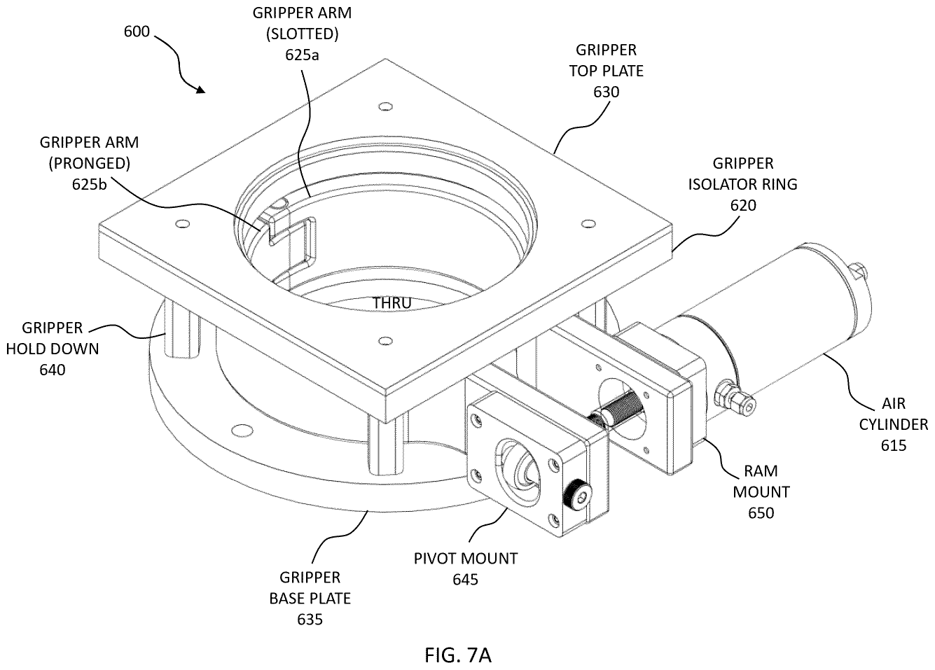

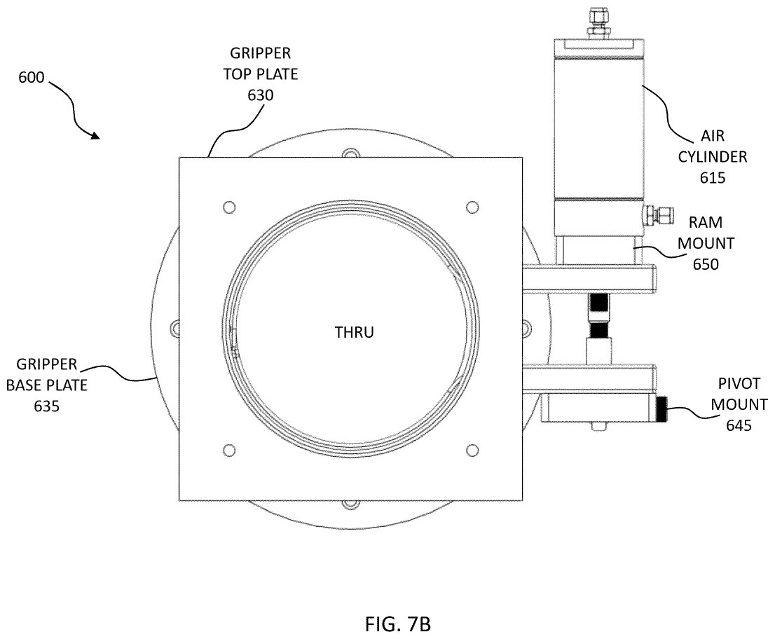

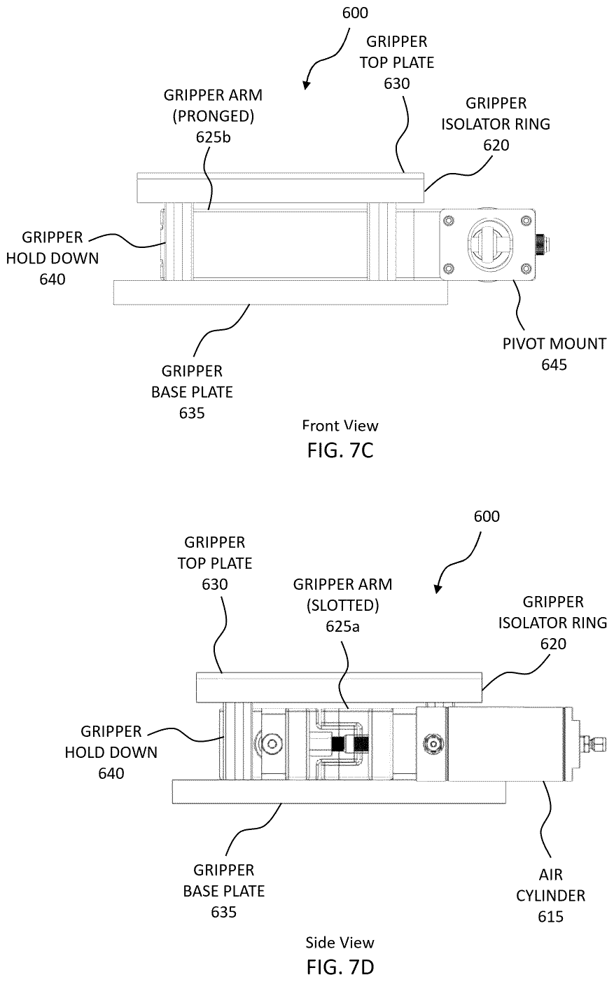

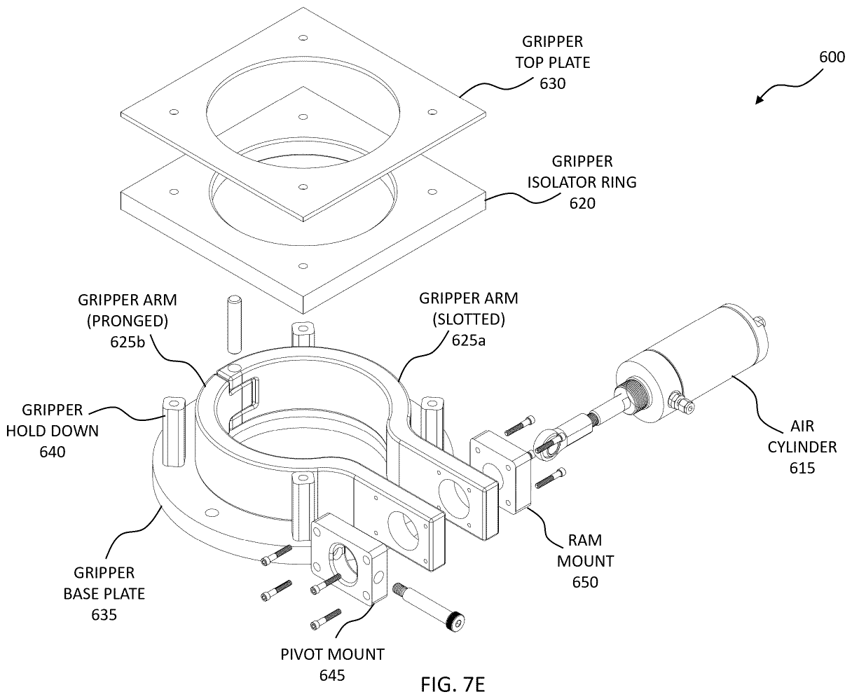

FIGS. 7A through 7E depict isometric, top, front, side, and exploded views, respectively, of an embodiment of a fixed gripper assembly 600. The depicted fixed gripper embodiment 600 comprises an air cylinder 615, a gripper isolator ring 620, a slotted gripper am 625a, a pronged gripper arm 625b, a gripper top plate 630, a gripper base plate 635, one or more gripper hold downs 640, a pivot mount 645, and a ram mount 650. In the depicted embodiment, the gripper top plate 630 is coupled to the top of the gripper isolator ring 620. The gripper top plate 630 and the gripper isolator ring 620 are coupled to one or more gripper hold downs 640 which are coupled to the gripper base plate 635. In the depicted embodiment, there are four gripper hold downs 640.

The prong on the pronged gripper am 625b fits into the slot on the slotted gripper arm 625a and the two arms are coupled together such that they may rotate about the coupling point. This movement allows for the strength of the grip to be tightened or loosened as needed. The assembly formed by the two gripper arms 625a,b rests atop the gripper base plate 635. The assembly formed by the two gripper arms 625a,b is prevented from moving vertically by the gripper isolator ring 620 and gripper top plate 630. The one or more gripper hold downs 640 control how wide the two arms 625a,b can open and/or prevent lateral slippage. The electrode 5, when installed, also prevents lateral slippage of the gripper arms 625a,b. The gripper base plate 635 aids in positioning the electrode 5 along the inner diameter of the gripper base plate 635. The gripper arms 625a,b control the ability of the electrode(s) 5 to move vertically, whereas the gripper base plate 635 controls alignment horizontally.

The linear ends of the gripper arms 625a,b are situated between a pivot mount 645 and a ram mount 650. Grip force is controlled by the air cylinder 615. The air cylinder 615 can induce pressure to pull the pivot mount 645 and the ram mount 650 toward each other to tighten the grip and reduce pressure to loosen the grip.

In some embodiments, one or more blocks may be located on the inside of the gripper arms 625a,b like the gripper embodiment depicted in FIGS. 4A through 4E. The one or more blocks may be composed of rubber or other insulating material. In some embodiments, the gripper isolator ring 620 and the one or more blocks serve to insulate the componentry from the electrode(s) (FIGS. 1 and 6C). The quantity and size of the blocks may vary between embodiments.

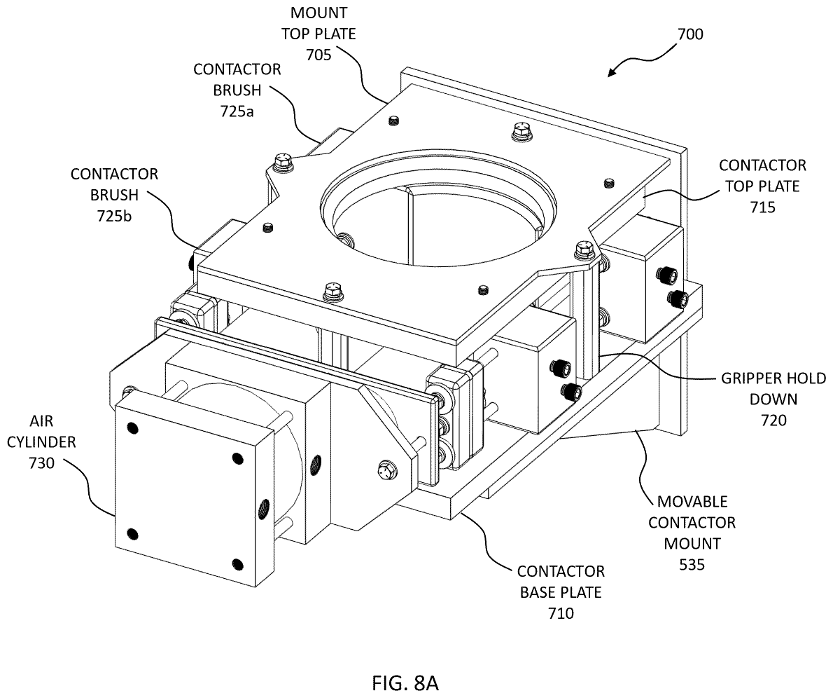

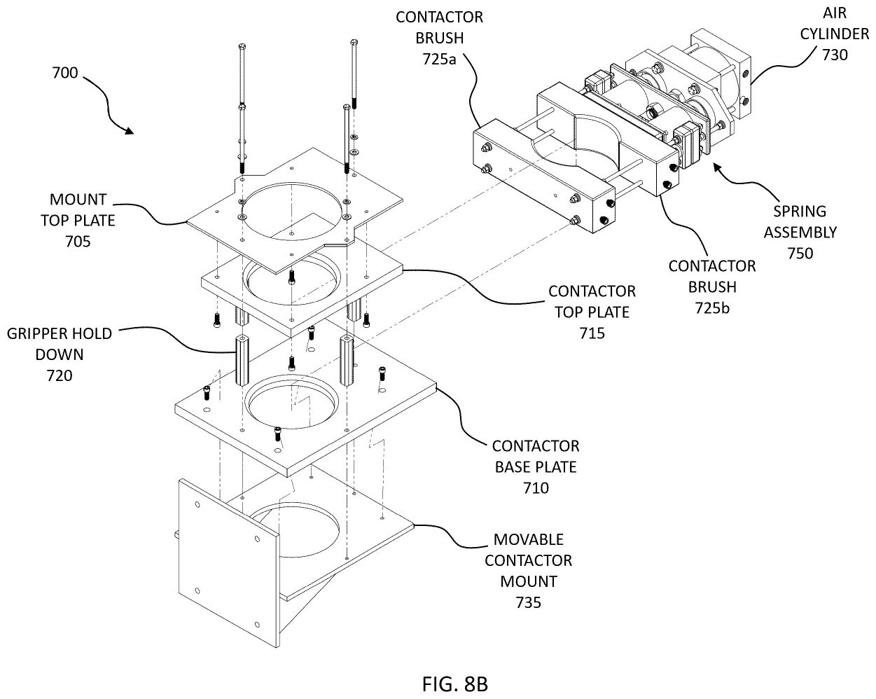

FIGS. 8A and 8B depict isometric and exploded views, respectively, of an embodiment of a movable contactor assembly 700. The depicted movable contactor 700 comprises a mount top plate 705, a contactor base plate 710, a contactor top plate 715, one or more gripper hold downs 720, contactor brushes 725a,b, air cylinder 730, movable contactor mount 735, and spring assembly 750. The movable contactor mount 735 and the mount top plate 705 form the outmost structure of the movable contactor assembly 700. The movable contactor mount 700 couples to sliders 520 (FIGS. 6A-6D) which facilitates vertically positioning and feeding of the electrode. The contactor 300 serves to control the amount of force applied to the electrode(s) 5 (FIGS. 1 and 6C).

The spring assembly 750 serves to cause the contactor brushes 725a,b to grip the electrode 5 (FIG. 1) when the air is vented from the air cylinder 730 as opposed to the movable gripper 201 (FIGS. 3A through 3E) that grips the electrode 5 (FIG. 1) when air is applied to the air cylinder. In the depicted embodiment, the contactor brushes 725a,b come in direct electrical contact with the electrode 5 (FIG. 1).

### General Information

While two embodiments are depicted and expressly disclosed, it should be obvious that any one or more aspects of the depicted and disclosed electrode feeder assemblies may be combined resulting in additional embodiments not expressly disclosed herein. Additionally, any disclosure of materials, weights, sizes, and/or methods of use in relation to one embodiment may apply to any other embodiments including those conceived but not directly disclosed herein and variations thereof. The modularity of components and the vast array of quantity, dimensions, and weights of the electrodes results in variations too numerous to expressly disclose and depict herein; however, the disclosure is enabling such that one of ordinary skill in the art can easily conceive the possible variations of the embodiments disclosed herein.

One or more parts of the electrode feeder embodiments may be composed of and/or coated with non-combustible materials. In some embodiments one or more parts of the electrode feeder embodiments may be composed of materials capable of withstanding high heat loads of 500° C. (+/−). In some embodiments, at least some of the structural componentry of the electrode feeder embodiments may be composed of painted/coated carbon steel. In some embodiments, electrical isolation between current carrying components and grounded components is maintained at least one of before, during, and after melt operations.

### Electrode Cap and Seal Assembly

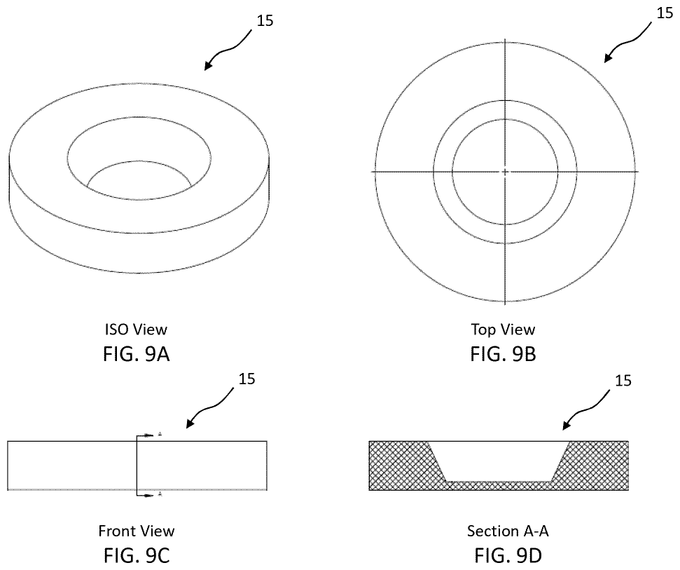

FIGS. 9A through 9D depict isometric, top, front, and section views, respectively, of an electrode cap 15 embodiment. In the depicted embodiment, the electrode cap 15 has a chamfered inner edge on an internal cavity. In some embodiments, an electrode cap 15 sits with the internal cavity side on top of each electrode for position tracking of the electrodes.

FIGS. 10A through 10C depict isometric, top, and section views, respectively, of an electrode seal assembly 1000 embodiment. In some embodiments, electrode seal assemblies 1000 are coupled to the hood of the vitrification container 1 (FIG. 2) to facilitate insertion of the electrode(s) 5 (FIG. 1) and to prevent gases from escaping the vitrification container 1 (FIG. 2). In some embodiments, any one or more components forming an embodiment of an electrode seal assembly 1000 may have one or more chamfered edges to facilitate insertion of an electrode 5 (FIG. 1) and to minimize potential for shavings to shear off the electrode 5 (FIG. 1). Each electrode seal assembly 1000 may provide at least one of thermal and electrical insulation for the one or more electrodes, in some embodiments. Each electrode seal assembly 1000 may provide pressure and gas/air flow isolation for the electrode from the vitrification container 1 (FIG. 2), in some embodiments. Each electrode seal assembly 1000 may provide an atmospheric seal while under differential pressure conditions, in some embodiments.

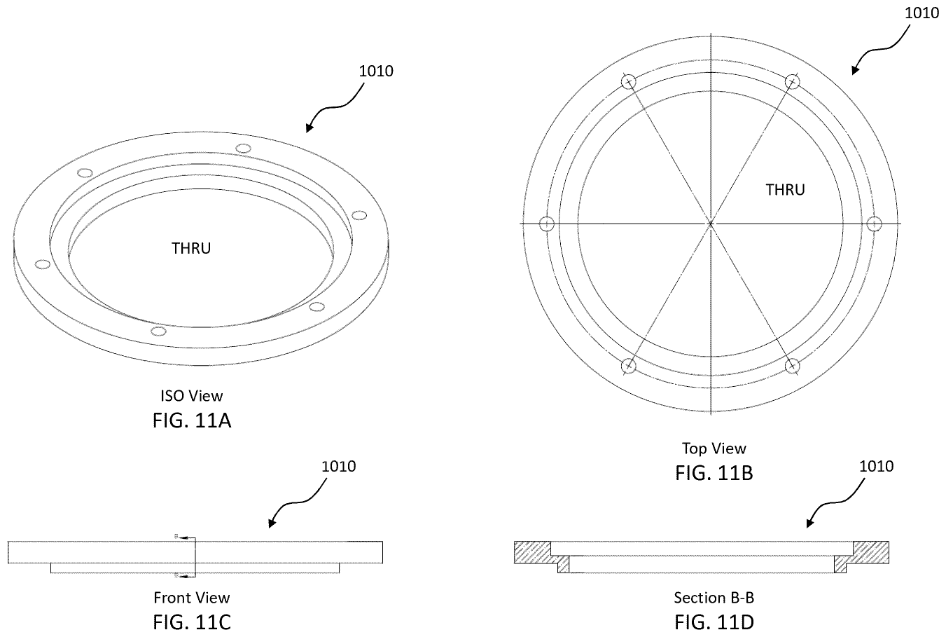

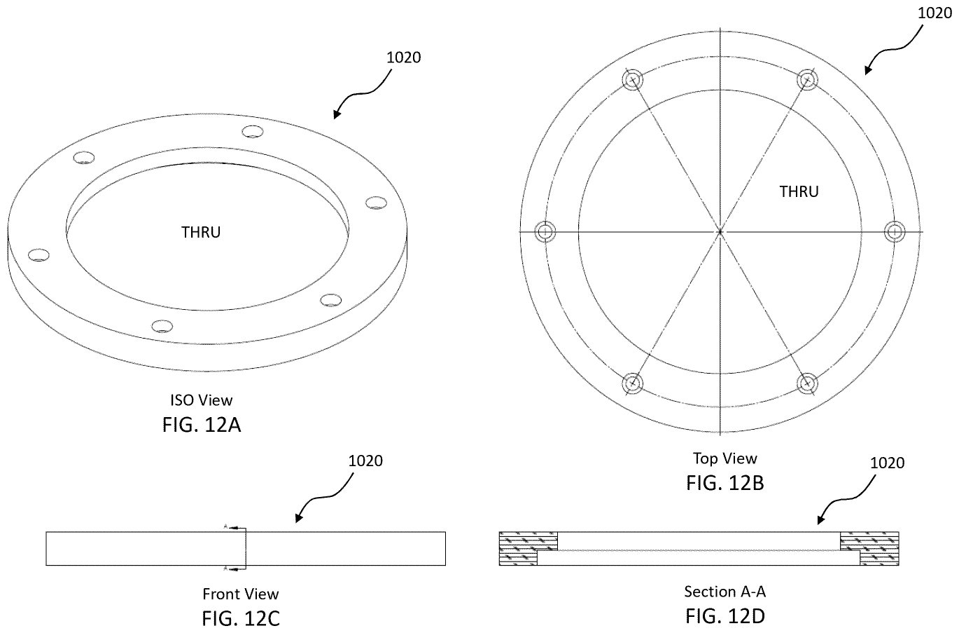

In the depicted embodiment, the electrode seal assembly 1000 embodiment comprises an electrode seal base 1010, an electrode seal cap 1020, and an electrode seal 1030. The electrode seal 1030 sits in between the electrode seal cap 1020 and the electrode seal base 1010. In some embodiments, a gasket 1040 may be included in between the electrode seal base 1010 and the top of the vitrification container 1 (FIG. 2). FIGS. 11A through 11D depict isometric, top, front, and section views, respectively, of an electrode seal base 1010 embodiment. The depicted electrode seal base 1010 is shaped to protrude into and to sit on the top of the vitrification container 1 (FIG. 2) to effect a seal. FIGS. 12A through 12D depict isometric, top, front, and section views, respectively, of an electrode seal cap 1020 embodiment. The electrode seal cap 1020 fits over the top of the electrode seal base 1010.

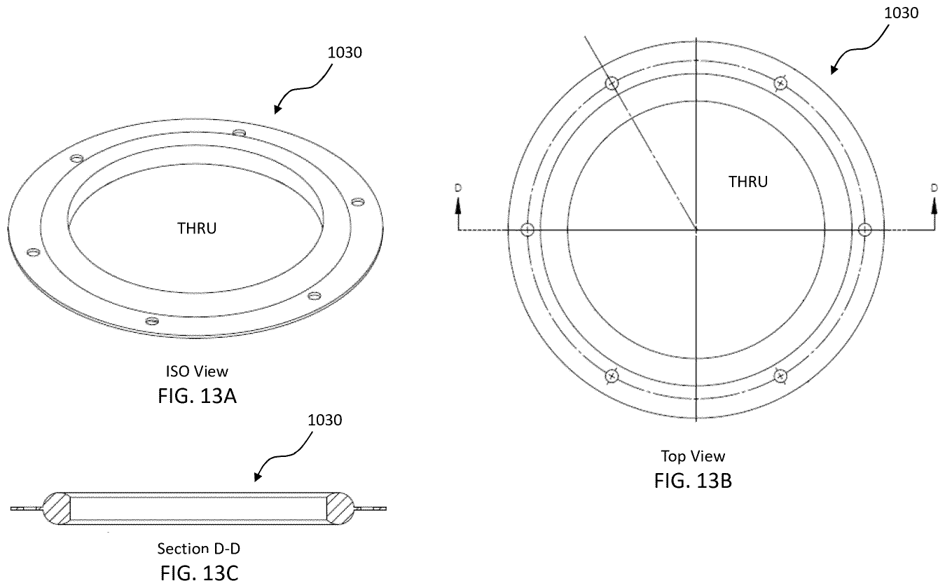

FIGS. 13A through 13C depict isometric, top, and section views, respectively, of an electrode seal 1030 embodiment. The depicted electrode seal 1030 is tadpole form comprising a cylindrical ring with a flat gasket edge that sits in between the electrode seal cap 1020 and electrode seal base 1010. The electrode seal 1030 protrudes into the interior of the electrode seal assembly 1000 slightly so that it is the primary portion of the electrode seal assembly 1000 that is in contact with the electrode. In some embodiments, the electrode seal 1030 has chamfered edges to facilitate electrode motion through the electrode seal assembly 1000 and so that the same force is applied on a smaller internal surface area, the higher-pressure results in an enhanced sealing effect.

In some embodiments, the electrode seal 1030 may be composed of graphite or flexible ceramic material (i.e., fiberglass or other ceramic material). Graphite is heat resistant, oxidation resistant, wear resistant, and has a low coefficient of friction. In some embodiments the electrode seal 1030 may contain at least 95% carbon content. Other materials may be used such as a flexible ceramic material or fiberglass. In some embodiments, the electrode seal 1030 may be wrapped in a material that, when subjected to heat and pressure, forms a thick, stable, and passivating oxide layer which protects the surface of the electrode seal 1030 from degradation. In some embodiments, the electrode seal 1030 may be wrapped with a material that is austenite nickel-chromium based. In some embodiments, the electrode seal 1030 may be Inconel® wrapped. In some embodiments, the Inconel® is spiral wrapped around the outer circumference of the electrode seal 1030. Inconel® increases resistance to corrosion at high temperatures as well as rigidity. The electrode seal 1030, in some embodiments, may be composed of a material that is rated for service in extreme environments including extreme heat and pressure (e.g., graphite).

### Methods of Use

There are a number of different methods of use that may be implemented depending on a number of factors including, but not limited to: electrode size, weight, type, and composition; heat load of the melt; and size of the melt. In some embodiments, there are three stages of use: pre-melt setup, melt, and post-melt. Only the vitrification processing steps relating to the electrode feeders are disclosed below. Periphery steps involving preparation of the vitrification container, waste material loading, off-gassing, and other processing steps are disclosed in co-pending application PCT/US2022/074945, titled Systems and Methods for Vitrification Process Control, filed Aug. 12, 2022.

### Pre-Melt

In some embodiments, electrodes from a previous melt may be in condition for reuse. Electrode segment(s) in good condition (minimal thread damage) may be reused as either upper or lower sections. Lower quality electrode segment(s) may be reused as lower sections. As a safety precaution, electrodes may have a secondary means of control apart from the grippers. They may one or more of be attached to the jib crane or other lifting device, have the hard stops in place below the feeders, and/or have a vitrification container in place under the hood.

Pre-Melt setup may proceed as follows, in some embodiments:

1. Open the movable grippers and the fixed grippers.

2. Ensure moveable grippers are fully lowered to the hard stop.

3. Attach a jib crane or other electrode lifting device to lower electrode sections.

4. Lower the lower electrode sections as far as possible into the electrode feeders.

5. Close the movable gripper and the fixed gripper until the lower electrode sections are secure and remove jib crane or other electrode lifting device.

6. Attach upper electrode sections via jib crane or other electrode lifting device.

7. Open the movable gripper and raise it to the top of the electrode. Close the movable gripper.

8. Open the fixed gripper. Fully lower electrode pairs (coupled upper and lower sections) into the melt zone.

9. Place the electrode position caps on top of the electrodes. Repeat for all electrode feeders.

10. Open and move all movable grippers to near the electrode feeder upper limit switch and close.

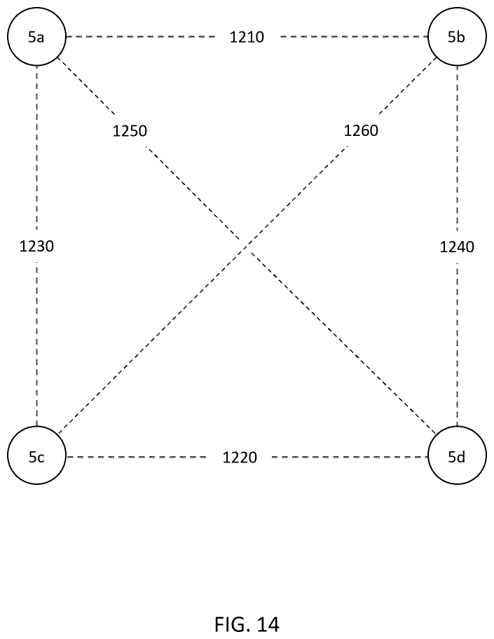

To ensure the system will be safe to operate, it is important in some embodiments to check electrical continuity between the electrodes. This may be done by measuring the resistance between all possible electrode connections with the electrodes in the starting position, but with the transformer out of the circuit. In the embodiment depicted in FIG. 14, four electrodes 5a, 5b, 5c, and 5d have six electrode connections 1210, 1220, 1230, 1240, 1250, and 1260. In some embodiments, additional graphite may be added, if needed, around electrodes. Additionally, resistance between the electrodes and vitrification container ground may be checked. The resistance between the electrodes and the vitrification container should be greater than 0.5E06 ohms, in some embodiments.

After performing the above steps, in some embodiments, the feeder system is ready for use in the vitrification process. Steps may vary between embodiments.

### Melt

The melt stage may proceed as follows, in some embodiments:

1. Check that the movable grippers have sufficient grip on the electrodes then open the fixed grippers to allow electrodes to be lowered during melt processing.

2. Observe electrode height indicators as the electrodes are progressing downward during melt processing to ensure that the maximum operating depth is not exceeded. Maximum operating depth may be the bottom of the container or higher, depending on the application.

3. Close the fixed grippers.

4. Open the movable grippers and re-position to the top of the electrodes.

5. Close the movable grippers.

6. Open the fixed grippers and resume electrode feeding.

7. Melt progress is determined via one or more of electrode depth, temperature measurements from one or more locations in the system, and visual indication from one or more cameras.

In some embodiments, there is a small (less than 2 inches, in some embodiments) height difference between electrodes though larger height differences (greater than 10 inches, in some embodiments) may occur as required to maintain stable operations. In some embodiments having more than one electrode feeder assembly, two or more movable grippers and/or movable contactors may be repositioned in tandem. In some embodiments, movable grippers and/or movable contactors may be repositioned individually. In some embodiments, feed rates may vary across electrode feeders. In some embodiments, electrode feed rates are the same (+/− acceptable error) for two or more electrode feeders.

### Sensors

One or more sensors and/or instruments may be used to monitor and control system properties. The positions and types of sensors and/or instruments may vary between embodiments. Types of sensors may comprise one or more of contact sensors, non-contact sensors, capacitive sensors, inductive sensors, 3D imagers, fiber optic cable, cameras, thermal imagers, thermometers, pressure sensors, radiation detectors, LIDAR, microphones, among others. In some embodiments, one or more infrared (IR) cameras, with or without radiation shielding, may be used in the system.

Some embodiments may comprise one or more imaging sensors. The one or more imaging sensors may comprise one or more of 3D imaging, 2D range sensor, camera (such as an IR camera or radiation shielded IR camera, in some embodiments), thermal imager, and radiation detector, among others. In some embodiments, thermocouples placed at one or more different heights within and around the container. One or more imaging sensors may be used to provide monitoring capabilities for remote operators. Signals from one or more imaging sensors may be displayed in real-time, recorded for later review, and/or recorded for operational records. Any one or more of the cameras may be one of fixed or pan-tilt-zoom types. An operator may select and manage desired camera views for operations, while controlling the cameras with associated control features such as the pan, tilt, zoom (PTZ), focus, and lights. In an embodiment, proper visual coverage of operations may be made possible by a camera system through adequate camera coverage, determined by camera quantity and location.

In some embodiments, one or more sensors may be located on or near the electrode feeder(s) to measure the vertical displacement of the electrode(s) from a fixed point to calculate the depth of electrode penetration within the melt. In some embodiments, position sensing is aided with the addition of an electrode end cap 15 (FIGS. 9A-9D) that is placed on the end of each electrode.

In some embodiments sensor data is used to control the operation of the system. Some embodiments may utilize sensor fusion algorithms to analyze data retrieved from one or more sensors of one or more different types. In some embodiments, the sensor data will automatically be analyzed and automatically effect changes in the control system for the process requiring little to no input from a human operator. In some embodiments, the sensor data and/or analysis is displayed for a human operator to perform manual adjustments.

### Control

System operations including feeding of the electrodes may be performed manually and/or automatically. Start, stop, and speed controls may be used for one or more operations in the control system. One or more of the motors and/or grippers may be air-actuated, in some embodiments. One or more of the motors and/or grippers may be controlled to prevent accidental release of gripper or contactor. In some embodiments, the control system may include a Human Machine Interface (HMI). In some embodiments, the HMI may include one or more of the following functions: Movable Gripper Air Drive Motor Position and Drive Direction; Fixed Gripper Position Output; Movable Gripper Position Output; and Contactor Gripper Position Output. Other functions are possible.

In some embodiments, the control system may capture, store, and trend key process and facility data including, but not limited to, feed rate. The feed rate may be a regular rate, automatically adjusted based on input from one or more sensors and/or imagers in the system, or manually adjusted. In some embodiments, data may be processed on-site in near real-time. In some embodiments, data and/or processed information may be transmitted to a remote location for long-term storage or processing.

The embodiments described above and illustrated in the figures are presented by way of example only and are not intended as a limitation upon the concepts and principles of the present disclosure. As such, it will be appreciated by one having ordinary skill in the art that various changes in the elements and their configuration and arrangement are possible without departing from the spirit and scope of the present disclosure as set forth in the appended claims.

In some embodiments, the electronic computing device 101 is used to control monitor and/or control the various aspects of the electrode feeder system. Any of the components described above can be incorporated into and/or used with the electronic computing device 101, which is described in greater detail below.

### Illustrative Embodiments

The following is a description of various embodiments of the disclosed subject matter. Each embodiment may include one or more of the various features, characteristics, or advantages of the disclosed subject matter. The embodiments are intended to illustrate a few aspects of the disclosed subject matter and should not be considered a comprehensive or exhaustive description of all possible embodiments.

P1. A method for feeding an electrode into a container using an electrode feeder system, comprising: (i) opening a fixed gripper, wherein the fixed gripper is coupled to a support frame at or near a fixed base plate; (ii) positioning a movable gripper at or near a lower limit switch wherein the lower limit switch is located at or near the fixed base plate, and wherein the movable gripper is coupled to one or more sliders, and the one or more sliders are coupled to the support frame; (iii) positioning the electrode through the fixed gripper and the movable gripper; (iv) closing the fixed gripper around the electrode; (v) positioning the movable gripper at or near an upper limit switch located at or near a top of the electrode feeder system; (vi) closing the movable gripper around the electrode; (vii) opening the fixed gripper; (viii) lowering the movable gripper along a length of the electrode feeder system causing the electrode to be lowered into the container; (ix) stopping lowering when the movable gripper comes into contact with the lower limit switch; (x) closing the fixed gripper; (xi) opening the movable gripper; (xii) raising the movable gripper to a position at or near the upper limit switch; (xiii) closing the movable gripper; (xiv) opening the fixed gripper; and (xv) repeating steps (viii)-(xiv) until at least one of a process occurring in the container is complete or the electrode is consumed.

P2. The method of P1, further comprising the steps of: (xvi) adding an electrode segment to the electrode; and (xvii) repeating steps (viii)-(xiv) until at least one of a process occurring in the container is complete or the electrode is consumed.

P3. The method of P2, further comprising: (xviii) opening all grippers.

P4. The method of P1, further comprising: (xvi) opening all grippers.

P5. The method of P1, comprising one or more electrode height indicators for monitoring electrode height.

P6. The method of P1, wherein the electrode is composed of graphite.

P7. The method of P1, wherein the electrode is lowered at a constant rate.

P8. The method of P1, wherein the electrode is lowered incrementally.

P9. The method of P1, further comprising one or more additional electrodes and one or more corresponding electrode feeder systems.

P10. The method of P9, wherein the one or more additional electrodes are fed in unison with the electrode.

P11. The method of P9, wherein the one or more additional electrodes are fed at one or more different rates than the electrode.

P12. The method of P1, wherein the electrode feeder system is at least partially comprised of or coated with steel or non-combustible materials.

P13. The method of P1, wherein the container comprises cast refractory materials.

P14. The method of P1, wherein the container includes one or more container walls that are removable.

P15. The method of P1, further comprising one or more sensors.

P16. The method of P15, wherein the one or more sensors comprise one or more of contact sensors, non-contact sensors, capacitive sensors, inductive sensors, 3D imagers, fiber optic cable, cameras, thermal imagers, thermometers, pressure sensors, radiation detectors, LIDAR, or microphones.

P17. The method of P1, wherein the method is automatically controlled using a control system.

P18. The method of P17, wherein the control system comprises a Human Machine Interface.

P19. The method of P17, wherein the control system at least one of captures, processes, stores, or trends data.

P20. The method of P19, wherein the data includes at least one of temperature, feed rate, or electrode depth.

P21. The method of P17, wherein the control system processes data in real-time.

P22. The method of P17, wherein the control system uses sensor data from one or more sensors to automatically control the electrode feeder system.

P23. An electrode feeder system, comprising: a base plate and a support frame, wherein the support frame is coupled to the base plate; a fixed gripper, wherein the fixed gripper is coupled to the support frame at or near the base plate; one or more sliders; a movable contactor, wherein the movable contactor is slidably coupled to the one or more sliders, and wherein the movable contactor comprises: a movable gripper, and a contactor, an upper limit switch, wherein the upper limit switch is coupled to at least one of the support frame or the one or more sliders; a lower limit switch, wherein the lower limit switch is coupled to at least one of the support frame, the base plate, or the one or more sliders; and a motor, wherein the motor is operable to cause the movable contactor to slide up or down along the one or more sliders.

P24. The system of P23, further comprising one or more electrode height indicators for monitoring electrode height.

P25. The system of P23, further comprising one or more sensors.

P26. The system of P25, wherein the one or more sensors comprise one or more of contact sensors, non-contact sensors, capacitive sensors, inductive sensors, 3D imagers, fiber optic cable, cameras, thermal imagers, thermometers, pressure sensors, radiation detectors, LIDAR, or microphones.

P27. The system of P23, wherein the system is at least partially comprised of or coated with steel or non-combustible materials.

P28. The system of P23, wherein the electrode feeder system comprises a container including cast refractory materials, and wherein the electrode feeder system is configured to feed an electrode into the container.

P29. The system of P23, wherein the electrode feeder system comprises a container including one or more container walls that are removable, and wherein the electrode feeder system is configured to feed an electrode into the container.

P30. The system of P23, comprising one or more electrode height indicators for monitoring electrode height.

P31. The system of P23, further comprising an electrode.

P32. The system of P31, wherein the electrode is composed of graphite.

P33. The system of P31, wherein the system is configured to lower the electrode at a constant rate.

P34. The system of P31, wherein the system is configured to lower the electrode incrementally.

P35. The system of P23, wherein the motor is an air motor.

P36. The system of P23, further comprising a control system.

P37. The system of P36, wherein the control system comprises a Human Machine Interface.

P38. The system of P36, wherein the control system at least one of captures, processes, stores, or trends key process or facility data.

P39. The system of P38, wherein the key process or facility data includes at least one of temperature, feed rate, or electrode depth.

P40. The system of P36, wherein the control system processes data in real-time.

P41. The system of P36, wherein the control system uses sensor data from one or more sensors to automatically control the electrode feeder system.

P42. A method for feeding an electrode into a container using an electrode feeder system, electrode feeder system comprising: a fixed gripper; a movable gripper axially aligned with the fixed gripper; the method comprising: (i) positioning the electrode through the fixed gripper and the movable gripper; (ii) gripping the electrode with the movable gripper; (iii) releasing the electrode from the fixed gripper; (iv) lowering the movable gripper while it is gripping the electrode; (v) gripping the electrode with the fixed gripper; (vi) releasing the electrode from the movable gripper; (vii) raising the movable gripper; and repeating steps (ii)-(vii).

P43. The method of P42, wherein the electrode feeder system comprises: a base plate; and a support frame; wherein the movable gripper moves along the support frame.

P44. The method of P42, comprising using the electrode to vitrify waste in a container.

P45. An electrode feeder system comprising: a base; a support frame coupled to the base; a fixed gripper coupled to at least one of the base or the support frame; and a movable gripper coupled to at least one of the base or the support frame and axially aligned with the fixed gripper along an axis, the movable gripper being movable toward and away from the fixed gripper along the axis.

P46. The electrode feeder system of P45, wherein the electrode feeder system is part of a system for vitrifying waste.

P47. The electrode feeder system of P45, wherein the electrode feeder system is positioned above a container of waste and the fixed gripper and the movable gripper are configured to lower an electrode into the container of waste.

### Electronic Computing Device

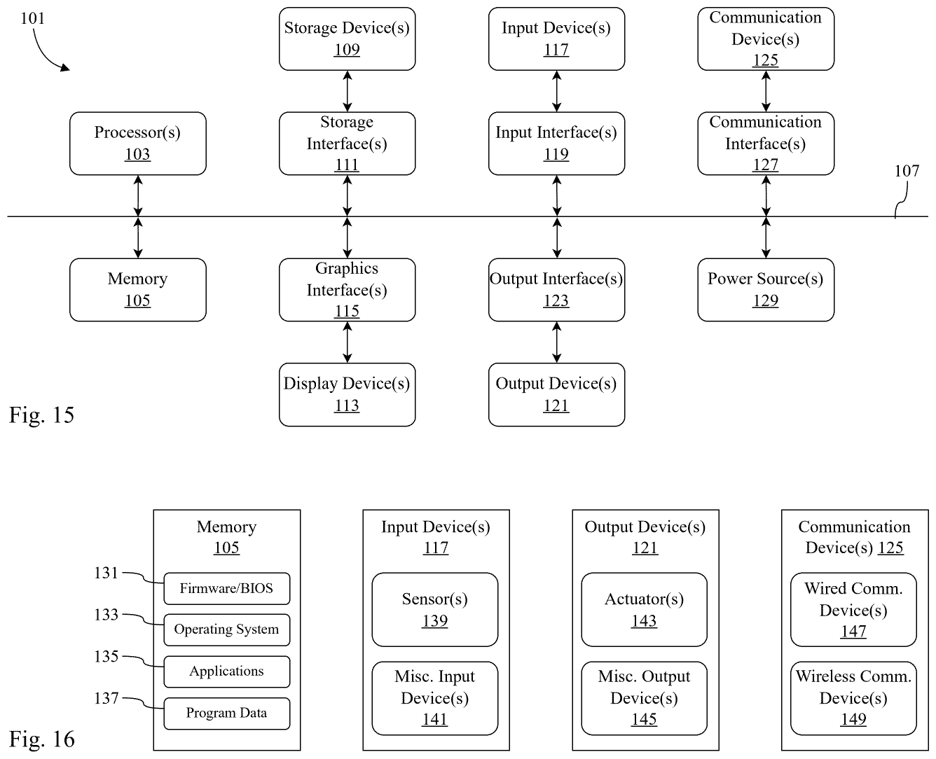

FIG. 15 shows one embodiment of an electronic computing device 101 (alternatively referred to as an electronic controller, programmable logic controller, electronic control system, or electronic computing system) that can be part of the electrode feeder system. The electronic computing device 101 can be used to control the electrode feeder in any of the ways described above. FIG. 16 shows embodiments of the devices that can be included as part of the electronic computing device 101.

The electronic computing device 101 includes one or more processors 103 (alternatively referred to as a digital processing unit or microprocessor) and memory 105 communicatively linked to each other by way of a system bus 107. In some embodiments, the electronic computing device 101 can also include one or more other interfaces and/or devices communicatively linked to the system bus 107.

For example, one or more storage devices 109 can be communicatively linked to the system bus 107 by way of one or more storage interfaces 111. One or more display devices 113 can be communicatively linked to the system bus 107 by way of one or more graphics interfaces 115. One or more input devices 117 can be communicatively linked to the system bus 107 by way of one or more input interfaces 119. One or more output devices 121 can be communicatively linked to the system bus 107 by way of one or more output interfaces 123. One or more communication devices 125 can be communicatively linked to the system bus 107 by way of one or more communication interfaces 127.

It should be appreciated that the electronic computing device 101 can have a variety of configurations. For example, in some embodiments, the various components of the electronic computing device 101 can be positioned near each other in a single housing, a few housings, a single board, a few boards communicatively linked together, or the like. In other embodiments, the various components of the electronic computing device 101 can be located remotely. For example, the one or more input devices 117 and/or the one or more output devices 121 can be located remotely or at a distance from the one or more processors 103 and/or the memory 105.

### Processor

Each of the one or more processors 103 is an electric circuit such as an integrated circuit that executes program instructions. The processor 103 can perform operations such as arithmetic operations, logic operations, controlling operations, and input/output (I/O) operations specified by the program instructions. In some embodiments, the processor 103 includes a control unit (CU), an arithmetic logic unit (ALU), and/or a memory unit (alternatively referred to as cache memory).

The control unit can direct the operation of the processor 103 and/or instruct the memory 105, arithmetic logic unit, and output devices 121 how to respond to instructions in the program. It can also direct the flow of data or information between the processor 103 and other components of the electronic computing device 101. It can also control the operation of other components by providing timing and control signals.

The arithmetic logic unit is an electric circuit in the processor 103 that performs integer arithmetic and bitwise logic operations. The arithmetic logic unit receives input in the form of data or information to be operated on and code describing the operation to be performed. The arithmetic logic unit provides the result of the performed operation as output. In some configurations, the arithmetic logic unit can also include status inputs and/or outputs that convey information about a previous operation or the current operation between the arithmetic logic unit and external status registers.

It should be appreciated that the processor 103 can have any suitable configuration. For example, the processor 103 can range from a simple processor specially built or configured to execute one or more programs for a specific application or device to a complex central processing unit configured to be used in a wide variety of ways and an equally wide variety of applications. Examples of processors 103 include a general-purpose processor, a digital signal processor (DSP), an application specific integrated circuit (ASIC), a central processing unit (CPU), a field programmable gate array (FPGA) or other programmable logic device, and/or discrete gate or transistor logic. The processor 103 can also be implemented as any individual or combination of these devices.

### Memory

The memory 105 (alternatively referred to as primary memory, main memory, or a computer-readable medium) is a semiconductor device or system used to store information for immediate use by the processor 103. The memory 105 is generally directly accessible to the processor 103. The processor 103 can read and execute program instructions stored in the memory 105 as well as store data and/or other information in the memory 105 that is actively being operated on. The memory 105 is generally more expensive and operates at higher speeds compared to the storage device 109. The memory 105 can be volatile such as random-access memory (RAM) or non-volatile such as read-only memory (ROM).

### System Bus

The system bus 107 broadly refers to the communication system through which information is transferred between the processor 103, the memory 105, and/or other components such as peripherals that can be considered part of the electronic computing device 101. The system bus 107 can include a physical system of connectors, conductive pathways, optical pathways, wires, or the like through which information travels.

The system bus 107 can have a variety of physical configurations. In some embodiments, the system bus can be configured as a backbone connecting the processor 103, the memory 105, and/or the various devices and/or interfaces as shown in the figure. In other embodiments, the system bus 107 can be configured as separate buses that communicatively link one or more components together. For example, the system bus 107 can include a bus communicatively linking the processor 103, the memory 105, and/or circuit board (the bus can alternatively be referred to as the front-side bus, memory bus, local bus, or host bus). The system bus 107 can include multiple additional I/O buses communicatively linking the various other devices and/or interfaces to the processor 103.

It should be appreciated that information shared between the components of the electronic computing device 101 can include program instructions, data, signals such as control signals, commands, bits, symbols, or the like. The information can be represented using a variety of different technologies and techniques. For example, in some embodiments, the information can be represented by voltages, currents, electromagnetic waves, magnetic fields or particles, optical fields, or the like.

The system bus 107 can also be used for other purposes besides sharing information. For example, the system bus 107 can be used to supply power from the power source 129 to the various devices and/or interfaces connected to the system bus 107. Likewise, the system bus 107 can include address lines which match those of the processor 103. This allows information to be sent to or from specific memory locations in the memory 105. The system bus 107 can also provide a system clock signal to synchronize the various devices and/or interfaces with the rest of the system.

The system bus 107 can use a variety of architectures, communication protocols, or protocol suites to communicatively link the processor 103, the memory 105, and/or any of the other devices and/or interfaces. For example, suitable architectures include Industry Standard Architecture (ISA), Extended Industry Standard Architecture (EISA), Micro Channel Architecture (MCA), Video Electronics Standards Association (VESA), Peripheral Component Interconnect (PCI), PCI Express (PCI-X), Personal Computer Memory Card Industry Association (PCMCIA or PC bus), Accelerated Graphics Port (AGP), Small Computer Systems Interface (SCSI), and the like. Suitable communication protocols include TCP/IP, IPX/SPX, Modbus, DNP, BACnet, ControlNet, Ethernet/IP, or the like.

### Program Instructions

The instructions stored in the electronic computing device 101 can include software algorithms and/or application programs. It should be appreciated that the software algorithms can be expressed in the form of methods or processes performed in part or entirely by the electronic computing device 101 or as instructions stored in a computer-readable medium such as the memory 105 and/or the storage device 109. Likewise, the software algorithms are shown in the flowcharts and described in the methods and/or processes.

It should be appreciated that instructions can take the form of entirely software (including firmware, resident software, micro-code, or the like), entirely hardware, or a combination of software and hardware. If implemented in software executed by the processor 103, the information may be stored on or transmitted over a computer-readable medium such as the memory 105 and/or the storage device 109. In some embodiments, the instructions can be contained in any tangible medium of expression having program code embodied in the medium. In some embodiments, the instructions can be written in any combination of one or more programming languages.

It should also be appreciated that the flowcharts, block diagrams, methods, and/or processes describe algorithms and/or symbolic representations of information operations. The algorithmic descriptions and representations are the means used by those skilled in the data processing arts to convey the substance of their work most effectively to others skilled in the art. These operations, while described functionally or logically, are understood to be implemented by software and/or hardware that can be readily and easily created from the functional or logical descriptions of the algorithms.

In some embodiments, the instructions can include firmware such as a basic input/output system (BIOS) 131, an operating system 133, one or more application programs 135, program data 137, and the like. These can be stored in the memory 105 and/or the storage device 109. In general, the instructions are stored in the memory 105 when the electronic computing device 101 is on and running or while the instructions are being used (e.g., an application program is running). Likewise, the instructions are stored in the storage device 109 when the electronic computing device 101 is off.

In some embodiments, the instructions are used to control operation of the electrode feeder 5—e.g., the sequential movements of the grippers and/or other devices described above.

### Storage Device

Each of the one or more storage devices 109 (alternatively referred to as secondary memory, or a computer-readable medium) is a device or system used to store information that is not needed for immediate use by the processor 103. The storage device 109 can be communicatively linked to the system bus 107 by way of a storage interface 111. The storage device 109 is generally not directly accessible to the processor 103. The storage device 109 is generally less expensive and operates at lower speeds compared to the memory 105. The storage device 109 is also generally non-volatile and used to permanently store the information.

The storage device 109 can take a variety of physical forms and use a variety of storage technologies. For example, in some embodiments, the storage device 109 can be in the form of a hard disk storage device, solid-state storage device, optical storage device, or the like. Also, in some embodiments, the storage device 109 can use technologies such as a magnetic disk (e.g., disk drives), laser beam (e.g., optical drives), semiconductor (e.g., solid-state drives), and/or magnetic tape to store information.

### Display Device

Each of the one or more display devices 113 (alternatively referred to as a human-machine interfaces (HMI) or screens) is a device that visually conveys text, graphics, video, and/or other information. In some embodiments, the information shown on the display device 113 exists electronically and is displayed for a temporary period of time. It should be appreciated that the display device 113 can operate as an output device and/or input device (e.g., touchscreen display or the like).

The display device 113 can be communicatively linked to the system bus 107 by way of one or more graphics interfaces 115. In some embodiments, the graphics interface 115 can be used to generate a feed of output images to the display device 113. In some embodiments, the graphics interface 115 can be a separate component such as a dedicated graphics card or chip or can be an integrated component that is part of or a subset of the processor 103.

It should be appreciated that the display device 113 can include a variety of physical structures and/or display technologies. For example, in some embodiments, the display device 113 can be a screen integrated into a specific application or technology, a separate screen such as a monitor, or the like. The display device 113 can also be a liquid crystal display, a light emitting diode display, a plasma display, a quantum dot display, or the like.

### Input Devices

Each of the one or more input devices 117 is a physical component that provides information to the processor 103 and/or the memory 105. The input device 117 can be communicatively linked to the system bus 107 by way of one or more input interfaces 119. The input device 117 can be any suitable type and can provide any of a variety of information. For example, the input device 117 can be a digital and/or analog device and can provide information in a digital or analog format. Also, the input device 117 can be used to provide user input for controlling the electronic computing device 101 or operational input for controlling aspects of a specific application.

The input device 117 can include one or more sensors 139 and/or one or more other miscellaneous input devices 141. It should be appreciated that the input device 117 is not limited to only providing information. In some embodiments, the input device 117 can also receive information. Such devices can be considered both an input device 117 and an output device 121.

The miscellaneous input device 141 can include a variety of devices or components. In some embodiments, the miscellaneous input devices 141 can include switches such as limit switches, level switches, vacuum switches, pressure switches, or the like, as well as buttons including pushbuttons or the like. In some embodiments, the miscellaneous input devices 141 include user interface components such as a pointing device, for example a mouse, text input devices, for example a keyboard, a touch screen, or the like.

### Sensors

Each of the one or more sensors 139 can be used to provide information about a wide variety of measured properties. In general terms, the sensor 139 is used to measure or detect information about its environment and send the information to the processor 103 and/or the memory 105. In some embodiments, the sensor 139 can operate as a transducer and generate an electrical signal as a function of the measured property. The electrical signal is communicated to the processor 103 and/or the memory 105 where it can be used for a variety of purposes.

The sensor 139 can be a digital sensor and/or an analog sensor. For example, in some embodiments, the sensor 139 provides digital information to the processor 103 and/or the memory 105. In other embodiments, the sensor 139 provides analog information to the processor 103 and/or the memory 105. Also, in some embodiments, the information can be converted from one type to the other—e.g., from digital to analog or from analog to digital.

It should be appreciated that the information provided by the sensor 139 can be used in a variety of ways by the processor 103. For example, in some embodiments, the processor 103 can compare the information to a set point. In some embodiments, analog information is amplified before being compared to the set point.

In some embodiments, the sensor 139 can be used to measure one or more properties. For example, the sensors 139 can be used to measure position, radiation, temperature, sound, and the like.

### Image Sensors

In some embodiments, the sensor 139 is an image sensor used to create an image of an aspect of the electrode feeder system and/or vitrification process. In general, an image sensor is a device that detects and conveys information used to make an image. The image sensor converts the variable attenuation of radiation waves (infrared, visible, and/or ultraviolet spectrum radiation as well as other frequencies) into signals that convey the information.

The image sensor can be any of a variety of types of image sensors. For example, suitable image sensors include electronic image sensors such as a charge-coupled device (CCD), active-pixel sensor (CMOS sensor), or the like. The image sensor can be part of a camera or other imaging device.

### Temperature Sensors

In some embodiments, the sensor 139 is a temperature sensor used to measure the temperature of vitrification process. Temperature is the physical quantity expressing the thermal energy present in matter. In some embodiments, the temperature sensor acts as a transducer and generates an electrical signal as a function of the measured temperature.

The temperature sensor can be a contact type temperature sensor or a non-contact type temperature sensor. Contact type temperature sensors are positioned in physical contact with the material and rely primarily on conduction to detect changes in its temperature. Non-contact type temperature sensors are not positioned in physical contact with the material and rely primarily on convection and/or radiation to detect changes in its temperature.

The temperature sensor can be any of a variety of types of temperature sensors. For example, suitable temperature sensors include thermocouples (type K, J, T, E, N, S, R, or the like), resistance temperature detectors (RTDs), thermistors, bimetallic strips, semiconductor temperature sensors, thermometers, vibrating wire temperature sensors, infrared temperature sensors, or the like.

### Pressure Sensors

In some embodiments, the sensor 139 is a pressure sensor used to measure the pressure of fluids such as pneumatic and/or hydraulic fluids. Pressure is an expression of the force required to stop the fluid from expanding and is expressed in force per unit area. In some embodiments, the pressure sensor acts as a transducer and generates an electrical signal as a function of the measured pressure.

The pressure sensor can be configured to measure a variety of pressures. In some embodiments, the pressure sensor is an absolute pressure sensor configured to measure the pressure relative to a vacuum. In some embodiments, the pressure sensor is a gauge pressure sensor configured to measure the pressure relative to ambient atmospheric pressure. In some embodiments, the pressure sensor is a differential pressure sensor configured to measure the difference between two pressures. In some embodiments, the pressure sensor is a sealed pressure sensor configure to measure the pressure relative to some fixed pressure other than ambient atmospheric pressure.

The pressure sensor can use a variety of pressure sensing technologies. In some embodiments, the pressure sensor can use force collecting pressure sensing technology. These types of electronic pressure sensors use a force collector such as a diaphragm, piston, bourdon tube, bellows, or the like, to measure strain or deflection due to applied force over an area. Examples of suitable force collector pressure sensors includes piezoresistive strain gauge pressure sensors, capacitive pressure sensors, electromagnetic pressure sensors, piezoelectric pressure sensors, strain-gauge pressure sensors, optical pressure sensors, potentiometric pressure sensors, force balancing pressure sensors, or the like. In some embodiments, the pressure sensor can use other properties such as density to infer pressure of a fluid.

### Position Sensors

In some embodiments, the sensor 139 is a position sensor configured to measure the position of the electrodes, grippers, and the like. The position sensor can be used to determine the absolute position or location of the component or the relative position or displacement of the component in terms of linear travel, rotational angle, or three-dimensional space. In some embodiments, the position sensor acts as a transducer and generates an electrical signal as a function of the measured position.

The position sensor can be a contact type position sensor or a non-contact type position sensor. Contact type position sensors are positioned in physical contact with the component to detect changes in its position. Non-contact type position sensors can detect changes in the position of the component without being in physical contact with it.

The position sensor can be any of a variety of types of position sensors and can be used to measure a variety of positions or movements including linear, rotary, and/or angular positions or movements. For example, suitable position sensors include potentiometric position sensors, inductive position sensors such as a linear variable differential transformer or a rotary variable differential transformer, eddy current-based position sensors, capacitive position sensors, magnetostrictive position sensors, hall effect-based magnetic position sensors, fiber optic position sensors, optical position sensors, ultrasonic position sensors, or the like.

### Light Sensors

In some embodiments, the sensor 139 is a light sensor configured to measure various aspects of the electrode feeder system and/or vitrification process. The light sensor can be used to determine the presence and/or intensity of light by measuring the radiant energy that exists in a certain range of frequencies, which typically include the infrared, visible, and/or ultraviolet light spectrum. In some embodiments, the light sensor acts as a transducer and generates an electrical signal as a function of the measured radiant energy.

The light sensor can include a variety of different light sensing technologies. In some embodiments, the light sensor generates electricity when illuminated. Examples of such light sensors include photovoltaic light sensors and photo-emissive light sensors. In some embodiments, the light sensor changes its electrical properties when illuminated. Examples of such light sensors include photoresistor light sensors and photoconductor light sensors.

### Output Devices

Each of the one or more output devices 121 is a physical component that receives information from the processor 103 and/or the memory 105. The output device 121 can be communicatively linked to the system bus 107 by way of one or more output interfaces 123. The output device 121 can be any suitable type and can receive any of a variety of information. For example, the output device 121 can be a digital and/or analog device and can receive information in a digital and/or analog format. Also, the output device 121 can be used to provide information to the user or perform various operations related to the specific application.

The output device 121 can include one or more actuators 143 and/or one or more other miscellaneous output devices 145. It should be appreciated that the output device 121 is not limited to only receiving information. In some embodiments, the output device 121 can also send information. Such devices can be considered both an output device 121 and an input device 117.

The miscellaneous output devices 145 can include a variety of devices or components. In some embodiments, the miscellaneous output devices 145 can include audio output devices such as speakers as well as other output devices.

### Actuators

Each of the one or more actuators 143 can be used to activate movement or an operation. In general terms, the actuator 143 is used to activate something in response to an instruction or control signal sent from the processor 103. In some embodiments, the actuator 143 can act as a transducer by receiving an electrical signal and transforming it into the desired movement or operation.

The information received by the actuator 143 can take a variety of forms and use a number of technologies. For example, the information may be in the form of an electric voltage or current, pneumatic or hydraulic fluid pressure, binary data, or the like. The information can be provided as digital and/or analog format. For example, in some embodiments, the actuator 143 receives digital information from the processor 103 or other component(s) in the electronic computing device 101. In other embodiments, the actuator 143 receives analog information from the processor 103 or other component(s) in the electronic computing device 101. Also, in some embodiments, the information received by the actuator 143 can be converted from one type to the other—e.g., from digital to analog or from analog to digital.

The actuator 143 can use a variety of energy sources to operate. For example, the actuator 143 can operate using electrical energy, hydraulic energy, pneumatic energy, thermal energy, magnetic energy, or the like. Likewise, the actuator 143 can be an electric actuator, hydraulic actuator, pneumatic actuator, thermal actuator, magnetic actuator, or the like. The actuator 143 can also be used to produce a variety of movements. For example, the actuator 143 can be used to produce linear movement and/or rotary movement.

### Motors

In some embodiments, the actuator 143 can include an electric motor. In general, the electric motor is a device that converts electrical energy to mechanical energy. In some embodiments, the mechanical energy produced by the electric motor is in the form of the rotation of a shaft. The mechanical energy can be used directly or converted into other mechanical movement using levers, gears, ratchets, cams, or the like. The motor can be a DC motor or an AC motor.

### Relays

In some embodiments, the actuator 143 can include a relay. In general, a relay is an electrically operated switch. In some embodiments, the relay includes one or more input terminals to receive information or control signals and one or more operating contact terminals electrically linked to a separate electrical device.

In some embodiments, the relays can include electromechanical relays having contacts that mechanically open and close. For example, the relay can include an electromagnet that opens and closes the contacts. In other embodiments, the relays can include solid state relays that use semiconductor properties to control the on or off state of the relay without any moving parts. Solid state relays can include thyristors and transistors to switch currents up to a hundred amps or more.

### Communication Devices

Each of the communication devices 125 is a physical component that allows the electronic computing device 101 to communicate with other devices, components, and/or networks. The communication device can be communicatively linked to the system bus 107 by way of one or more communication interfaces 127. The communication device 125 can include one or more wired communication devices 147 and/or one or more wireless communication devices 149.

It should be appreciated that the communication device 125 can be any suitable physical device. For example, in some embodiments, the communication device 125 is a network interface controller used to connect the electronic computing device 101 to a larger network such as a local area network (LAN), wide area network (WAN), or the Internet.

It should also be appreciated that the communication device 125 can use a variety of communication protocols. For example, in some embodiments, the wired communication device 147 can use communication protocols such as Ethernet, RS-232, RS-485, USB, or the like. Also, in some embodiments, the wireless communication devices 149 can use communication protocols such as Wi-Fi, Bluetooth, Zigbee, LTE, 5G, or the like.

### Power Source

The power source 129 can be used to supply electric power to the electronic computing device 101. The power source 129 can provide any suitable type of power including AC power, DC power, or the like. The power source 129 can obtain power from any suitable source including an AC power source (standard wall outlet), DC power source (a transformer plugged into a wall outlet), battery, generator, or the like.

In some embodiments, the power source 129 includes a power supply that converts electric current from a source to a desired voltage, current, and/or frequency to power the electronic computing device 101. In some embodiments, the power supply can convert AC power ranging from 110-240 VAC to DC power ranging from 6-60 VDC.

### Circuit Board

The electronic computing device 101 can include one or more circuit boards (alternatively referred to as logic boards) to which one or more of the components can be coupled. For example, the processor 103, the memory 105, the storage device 109, the display device 113, the input device 117, the output device 121, the communication device 125, and/or the power source 129 can be coupled to one or more circuit boards. In some embodiments, the processor 103, the memory 105, and/or the storage device 109 can be coupled to one circuit board.

In some embodiments, the circuit board can contain a series of conductive tracks, pads, and/or other features etched from one or more sheet layers of copper laminate laminated onto and/or between sheet layers of nonconductive substrate. The conductive features can be part of the system bus 107 communicatively linking the various components of the electronic computing device 101. In some embodiments, the circuit board can be a printed circuit board. In some embodiments, the circuit board can be a motherboard.

### General Terminology and Interpretative Conventions

Any methods described in the claims or specification should not be interpreted to require the steps to be performed in a specific order unless expressly stated otherwise. Also, the methods should be interpreted to provide support to perform the recited steps in any order unless expressly stated otherwise.

Certain features described in the context of separate embodiments can also be implemented in combination in a single embodiment. Conversely, various features that are described in the context of a single embodiment can also be implemented in multiple embodiments separately or in any suitable subcombination. Moreover, although features may be described above in certain combinations and even initially claimed as such, one or more features from a claimed combination can be excised from the combination, and the claimed combination may be directed to a subcombination or variation of a subcombination.

The example configurations described in this document do not represent all the examples that may be implemented or that are within the scope of the claims. The term “example” shall be interpreted to mean “serving as an example, instance, or illustration,” and not “preferred” or “advantageous over other examples.”

Articles such as “the,” “a,” and “an” can connote the singular or plural. Also, the word “or” when used without a preceding “either” (or other similar language indicating that “or” is unequivocally meant to be exclusive—e.g., only one of x or y, etc.) shall be interpreted to be inclusive (e.g., “x or y” means one or both x or y).

The term “and/or” shall also be interpreted to be inclusive (e.g., “x and/or y” means one or both x or y). In situations where “and/or” or “or” are used as a conjunction for a group of three or more items, the group should be interpreted to include one item alone, all the items together, or any combination or number of the items.

The phrase “based on” shall be interpreted to refer to an open set of conditions unless unequivocally stated otherwise (e.g., based on only a given condition). For example, a step described as being based on a given condition may be based on the recited condition and one or more unrecited conditions.

The terms have, having, contain, containing, include, including, and characterized by should be interpreted to be synonymous with the terms comprise and comprising—i.e., the terms are inclusive or open-ended and do not exclude additional unrecited subject matter. The use of these terms should also be understood as disclosing and providing support for narrower alternative embodiments where these terms are replaced by “consisting of,” “consisting of the recited subject matter plus impurities and/or trace amounts of other materials,” or “consisting essentially of.”

Unless otherwise indicated, all numbers or expressions, such as those expressing dimensions, physical characteristics, or the like, used in the specification (other than the claims) are understood to be modified in all instances by the term “approximately.” At the very least, and not as an attempt to limit the application of the doctrine of equivalents to the claims, each numerical parameter recited in the specification or claims which is modified by the term “approximately” should be construed in light of the number of recited significant digits and/or by applying ordinary rounding techniques.

All disclosed ranges are to be understood to encompass and provide support for claims that recite any subranges or any individual values subsumed by each range. For example, a stated range of 1 to 10 should be considered to include and provide support for claims that recite any subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth), which values can be expressed alone or as a minimum value (e.g., at least 5.8) or a maximum value (e.g., no more than 9.9994).

All disclosed numerical values are to be understood as being variable from 0-100% in either direction and thus provide support for claims that recite such values (either alone or as a minimum or a maximum—e.g., at least <value> or no more than <value>) or any ranges or subranges that can be formed by such values. For example, a stated numerical value of 8 should be understood to vary from 0 to 16 (100% in either direction) and provide support for claims that recite the range itself (e.g., 0 to 16), any subrange within the range (e.g., 2 to 12.5) or any individual value within that range expressed individually (e.g., 15.2), as a minimum value (e.g., at least 4.3), or as a maximum value (e.g., no more than 12.4).

The terms recited in the claims should be given their ordinary and customary meaning as determined by reference to relevant entries in widely used general dictionaries and/or relevant technical dictionaries, commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used in a manner that is more expansive than its ordinary and customary meaning, the term should be given its ordinary and customary meaning plus the additional expansive meaning, or (b) if a term has been explicitly defined to have a different meaning by reciting the term followed by the phrase “as used in this document shall mean” or similar language (e.g., “this term means,” “this term is defined as,” “for the purposes of this disclosure this term shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained in this document should be considered a disclaimer or disavowal of claim scope.

None of the limitations in the claims should be interpreted as invoking 35 U.S.C. 112(f) unless the words “means for” or “step for” are explicitly recited in the claim.

Unless explicitly stated otherwise or otherwise apparent from context, terms such as “processing,” “computing,” “calculating,” “determining,” “displaying,” or the like, refer to the action and processes of an electronic computing device including a processor and memory.

The subject matter recited in the claims is not coextensive with and should not be interpreted to be coextensive with any embodiment, feature, or combination of features described or illustrated in this document. This is true even if only a single embodiment of the feature or combination of features is illustrated and described.

### Joining or Fastening Terminology and Interpretative Conventions

The term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature.

The term “coupled” includes joining that is permanent in nature or releasable and/or removable in nature. Permanent joining refers to joining the components together in a manner that is not capable of being reversed or returned to the original condition. Releasable joining refers to joining the components together in a manner that is capable of being reversed or returned to the original condition.

Releasable joining can be further categorized based on the difficulty of releasing the components and/or whether the components are released as part of their ordinary operation and/or use. Quickly releasable joining (i.e., quick-release) refers to joining that that can be released without the use of tools. Readily or easily releasable joining refers to joining that can be readily, easily, and/or promptly released with little or no difficulty or effort. Some joining can qualify as both quickly releasable joining and readily or easily releasable joining. Other joining can qualify as one of these types of joining but not the other. For example, one type of joining may be readily or easily releasable but also require the use of a tool.

Non-quickly releasable joining (i.e., non-quick-release) refers to joining that can only be released with the use of tools. Difficult or hard to release joining refers to joining that is difficult, hard, or arduous to release and/or requires substantial effort to release. Some joining can qualify as both non-quickly releasable joining and difficult or hard to release joining. Other joining can qualify as one of these types of joining but not the other. For example, one type of joining may require the use of a tool but may not be difficult or hard to release.

The joining can be released or intended to be released as part of the ordinary operation and/or use of the components or only in extraordinary situations and/or circumstances. In the latter case, the joining can be intended to remain joined for a long, indefinite period until the extraordinary circumstances arise.

It should be appreciated that the components can be joined together using any type of fastening method and/or fastener. The fastening method refers to the way the components are joined. A fastener is generally a separate component used in a mechanical fastening method to mechanically join the components together. A list of examples of fastening methods and/or fasteners is given below. The list is divided according to whether the fastening method and/or fastener is generally permanent, readily released, or difficult to release.

Examples of permanent fastening methods include welding, soldering, brazing, crimping, riveting, stapling, stitching, some types of nailing, some types of adhering, and some types of cementing. Examples of permanent fasteners include some types of nails, some types of dowel pins, most types of rivets, most types of staples, stitches, most types of structural ties, and toggle bolts.

Examples of readily releasable fastening methods include clamping, pinning, clipping, latching, clasping, buttoning, zipping, buckling, and tying. Examples of readily releasable fasteners include snap fasteners, retainer rings, circlips, split pin, linchpins, R-pins, clevis fasteners, cotter pins, latches, hook and loop fasteners (VELCRO), hook and eye fasteners, push pins, clips, clasps, clamps, zip ties, zippers, buttons, buckles, split pin fasteners, and/or confirm at fasteners.

Examples of difficult to release fastening methods include bolting, screwing, most types of threaded fastening, and some types of nailing. Examples of difficult to release fasteners include bolts, screws, most types of threaded fasteners, some types of nails, some types of dowel pins, a few types of rivets, a few types of structural ties.

It should be appreciated that the fastening methods and fasteners are categorized above based on their most common configurations and/or applications. The fastening methods and fasteners can fall into other categories or multiple categories depending on their specific configurations and/or applications. For example, rope, string, wire, cable, chain, or the like can be permanent, readily releasable, or difficult to release depending on the application.

### Drawing Related Terminology and Interpretative Conventions

Reference numbers in the drawings and corresponding description refer to identical or similar elements although such numbers may be referenced in the context of different embodiments.

The drawings are intended to illustrate embodiments that are both drawn to scale and/or not drawn to scale. This means the drawings can be interpreted, for example, as showing: (a) everything drawn to scale, (b) nothing drawn to scale, or (c) one or more features drawn to scale and one or more features not drawn to scale. Accordingly, the drawings can serve to provide support to recite the sizes, proportions, and/or other dimensions of any of the illustrated features either alone or relative to each other. Furthermore, all such sizes, proportions, and/or other dimensions are to be understood as being variable from 0-100% in either direction and thus provide support for claims that recite such values or any ranges or subranges that can be formed by such values.

Spatial or directional terms, such as “left,” “right,” “front,” “back,” or the like, relate to the subject matter as it is shown in the drawings and/or how it is commonly oriented during manufacture, use, or the like. However, it is to be understood that the described subject matter may assume various alternative orientations and, accordingly, such terms are not to be considered as limiting.

### INCORPORATION BY REFERENCE

The entire content of each document listed below is incorporated by reference into this document (the documents below are collectively referred to as the “incorporated documents”). If the same term is used in both this document and one or more of the incorporated documents, then it should be interpreted to have the broadest meaning imparted by any one or combination of these sources unless the term has been explicitly defined to have a different meaning in this document. If there is an inconsistency between any incorporated document and this document, then this document shall govern. The incorporated subject matter should not be used to limit or narrow the scope of the explicitly recited or depicted subject matter.

Priority patent documents incorporated by reference:
U.S. Prov. App. No. 63/267,086, titled “Systems and Methods for Electrode Feeders and Electrode Seals,” filed on 24 Jan. 2022.

Additional documents incorporated by reference:
Int'l Pat. Pub. No. TBD (App. No. PCT/US2022/074945), titled “Systems and Methods for Vitrification Process Control,” filed on 12 Aug. 2022, published on TBD.
U.S. Pat. No. 10,486,969 (application Ser. No. 14/294,033), titled “Balanced Closed Loop Continuous Extraction Process for Hydrogen Isotopes,” filed on 2 Jun. 2014, issued on 26 Nov. 2019.
U.S. Pat. No. 10,449,581 (application Ser. No. 15/388,299), titled “System and Method for an Electrode Seal Assembly,” filed on 22 Dec. 2016, issued on 22 Oct. 2019.
U.S. Pat. No. 10,311,989 (application Ser. No. 15/603,222), titled “System for Storage Container with Removable Shield Panels,” filed on 23 May 2017, issued on 4 Jun. 2019.
U.S. Pat. No. 10,290,384 (application Ser. No. 15/012,101), titled “Ion Specific Media Removal from Vessel for Vitrification,” filed on 1 Feb. 2016, issued on 14 May 2019.
U.S. Pat. No. 9,981,868 (application Ser. No. 14/748,535), titled “Mobile Processing System for Hazardous and Radioactive Isotope Removal,” filed on 24 Jun. 2015, issued on 29 May 2018.
U.S. Pat. No. 7,429,239 (application Ser. No. 11/796,263), titled “Methods for Melting of Materials to be Treated,” filed on 27 Apr. 2007, issued on 30 Sep. 2008.
U.S. Pat. No. 7,211,038 (application Ser. No. 10/808,929), titled “Methods for Melting of Materials to be Treated,” filed on 25 Mar. 2004, issued on 1 May 2007.
U.S. Pat. No. 6,941,878 (application Ser. No. 10/605,384), titled “Advanced Vitrification System 2,” filed on 26 Sep. 2003, issued on 13 Sep. 2005.
U.S. Pat. No. 6,558,308 (application Ser. No. 10/063,460), titled “AVS Melting Process,” filed on 25 Apr. 2002, issued on 6 May 2003.
U.S. Pat. No. 6,283,908 (application Ser. No. 09/564,774), titled “Vitrification of Waste with Continuous Filling and Sequential Melting,” filed on 4 May 2000, issued on 4 Sep. 2001.

1-22. (canceled)

23. An electrode feeder system, comprising:
a base plate and a support frame, wherein the support frame is coupled to the base plate;
a fixed gripper, wherein the fixed gripper is coupled to the support frame at or near the base plate;
one or more sliders;
a movable contactor, wherein the movable contactor is slidably coupled to the one or more sliders, and wherein the movable contactor comprises:
a movable gripper, and
a contactor,
an upper limit switch, wherein the upper limit switch is coupled to at least one of the support frame or the one or more sliders;
a lower limit switch, wherein the lower limit switch is coupled to at least one of the support frame, the base plate, or the one or more sliders; and
a motor, wherein the motor is operable to cause the movable contactor to slide up or down along the one or more sliders.

24. (canceled)

25. The system of claim 23, further comprising one or more sensors.

26. The system of claim 25, wherein the one or more sensors comprise one or more of contact sensors, non-contact sensors, capacitive sensors, inductive sensors, 3D imagers, fiber optic cable, cameras, thermal imagers, thermometers, pressure sensors, radiation detectors, LIDAR, or microphones.

27. The system of claim 23, wherein the system is at least partially comprised of or coated with steel or non-combustible materials.

28. The system of claim 23, wherein the electrode feeder system comprises a container including cast refractory materials, and wherein the electrode feeder system is configured to feed an electrode into the container.

29. The system of claim 23, wherein the electrode feeder system comprises a container including one or more container walls that are removable, and wherein the electrode feeder system is configured to feed an electrode into the container.

30. The system of claim 23, comprising one or more electrode height indicators for monitoring electrode height.

31. The system of claim 23, further comprising an electrode.

32. The system of claim 31, wherein the electrode is composed of graphite.

33. The system of claim 31, wherein the system is configured to lower the electrode at a constant rate.

34. The system of claim 31, wherein the system is configured to lower the electrode incrementally.

35. The system of claim 23, wherein the motor is an air motor.

36. The system of claim 23, further comprising a control system.

37. The system of claim 36, wherein the control system comprises a Human Machine Interface.

38. The system of claim 36, wherein the control system at least one of captures, processes, stores, or trends key process or facility data.

39. The system of claim 38, wherein the key process or facility data includes at least one of temperature, feed rate, or electrode depth.

40. The system of claim 36, wherein the control system processes data in real-time.

41. The system of claim 36, wherein the control system uses sensor data from one or more sensors to automatically control the electrode feeder system.
